(19) United States
(12) Patent Application Publication
(10) Pub. No.: US 2022/0184611 A1
(43) Pub. Date: Jun. 16, 2022

(54) MICROFLUIDIC SYSTEM, MICROFLUIDIC CHIP, AND OPERATING METHOD

(71) Applicant: Sony Group Corporation, Tokyo (JP)

(72) Inventors: Shin Masuhara, Tokyo (JP); Nobuaki Kuribara, Saitama (JP); Tasuku Yotoriyama, Tokyo (JP); Isamu Nakao, Kanagawa (JP)

(73) Assignee: Sony Group Corporation, Tokyo (JP)

(21) Appl. No.: 17/603,309

(22) PCT Filed: Apr. 16, 2020
(86) PCT No.: PCT/JP2020/016691

§ 371 Date: Oct. 12, 2021

(30) Foreign Application Priority Data
Apr. 19, 2019 (JP) 2019-080082

(51) Int. Cl. B01L 3/00

(52) U.S. Cl. CPC B01L 3/50273; B01L 3/502715; B01L 2300/0803; B01L 2300/0663; B01L 2300/0819; B01L 2300/0829; B01L 2400/0433

(57) ABSTRACT

Provided is a microfluidic system comprising a microfluidic chip including a substrate having a vibrating section that, when irradiated by light, causes at least a portion of a substrate to vibrate, and at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.

### CROSS REFERENCE TO RELATED APPLICATIONS

This application claims the benefit of Japanese Priority Patent Application JP 2019-080082 filed Apr. 19, 2019, the entire contents of which are incorporated herein by reference.

### TECHNICAL FIELD

The present technology relates to a particle operating method, a particle trapping chip, a particle operating system, and a particle trapping chamber. More specifically, the present technology relates to a particle operating method carried out for operating one particle, a particle trapping chip used for operating one particle, and a particle operating system and a particle trapping chamber that include the particle trapping chip.

### BACKGROUND ART

Attention is being paid to a single cell analyzing technology. In the single cell analyzing technology, trapping of one cell each in each of many microwells arranged on a flat surface, and individually observing the forms of respective cells and analyzing the characteristic of each of the cells, and/or analyzing reactions of the respective cells with reagents using, for example, fluorescence or the like as an indicator, may be performed. Then, as a result of the analysis, the desired cells may selectively be taken out from the microwells and be recovered, one by one.

There have been proposed some techniques for recovering the cells in the single cell analyzing technology. For example, in a cell picking system (AS ONE Corporation), the desired cells are sucked out by use of a capillary tube and then automatically conveyed onto a microplate. Some manipulators of similar systems have already been commercialized as well.

In addition, as techniques other than suction, some cell recovery methods using laser light have also been proposed.

For example, PTL 1 mentioned below discloses a method for sorting and recovering biological targets on a flat carrier. The method includes a process in which target areas of the carrier where the selected biological targets are disposed are cut out by a laser beam.

In addition, NPL 1 mentioned below describes that a cell was taken out from inside of a microwell by what is generally called an optical tweezers effect by laser light. Besides, NPL 2 mentioned below describes a method in which a liquid in a microwell is heated by laser light to generate a bubble, and a cell is pushed out from the microwell by the bubble.

### CITATION LIST

### Patent Literature

PTL 1: JP 2000-504824A

### Non Patent Literature

NPL 1: Intuitive, Image-Based Cell Sorting Using Optofluidic Cell Sorting, J. R. Kovac and J. Voldman., Anal. Chem., 2007, 79(24), pp. 9321-9330
NPL 2: A Trap-and-Release Integrated Microfluidic System for Dynamic Microarray Applications, Wei-Heong TAN and Shoji TAKEUCHI, Proc. Natl. Acad. Sci. USA, 2007, 104(4), pp. 1146-1151

### SUMMARY

### Technical Problem

It takes a long period of time to selectively recover many cells by the micromanipulator. In addition, for example, from the viewpoint of preventing contamination, microwells are sometimes provided in a closed space, and the cell recovery by use of the micromanipulator may cause contact between the closed space and outside air.

In the cell recovery method described in the abovementioned PTL 1, target areas of the carrier where the cells are present may be cut out by the laser beam, and, thereafter, the cells may further be separated from the thus cut-out carrier. However, since the cell recovery method includes the cutting-out step, it takes a lot of time to selectively recover many cells.

The cell recovery methods using laser light described in the abovementioned NPL 1 and NPL 2 may permit the cells in the microwells provided in a closed space to be recovered while preventing the contact between the closed space and the outside air. However, even by use of either of the techniques, it still takes a long period of time to selectively recover many cells.

It is desirable to provide a novel technique for selectively recovering many cells.

### Solution to Problem

The present inventors have found out that the above-mentioned problem can be solved by a specific microfluidic system.

Specifically, a microfluidic system according to one mode of the present technology comprises a microfluidic chip including a substrate having a vibrating section that, when irradiated by light, causes at least a portion of a substrate to vibrate, and at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.

A microfluidic chip according to one mode of the present technology comprises a substrate having a vibrating section that, when irradiated by light, causes at least a portion of a substrate to vibrate, and at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.

An operating method for a microfluidic system, according to one mode of the present technology comprises irradiating a vibrating section of a substrate with light to cause vibration of at least a portion of the substrate, wherein the vibration of the at least a portion of the substrate causes a vibration stimulus within at least one microfluidic structure arranged adjacent to the at least a portion of the substrate.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

FIG. 1A is a schematic diagram of an example of a particle trapping chamber used in a particle operating method according to an embodiment of the present technology.

FIG. 1B is a schematic perspective view of an example of the particle trapping chamber used in the particle operating method according to an embodiment of the present technology.

FIG. 1C is a photograph and a schematic diagram depicting an example of a particle trapping region and a metallic ring surrounding the particle trapping region.

FIG. 2 is a schematic diagram depicting an example of particle operation in the particle operating method according to an embodiment of the present technology.

FIG. 3 is a schematic diagram depicting an example of the manner of recovering particles.

FIG. 4 is a schematic diagram of an example of a particle trapping chip used in the particle operating method according to an embodiment of the present technology.

FIG. 5 is a schematic diagram of an example of the particle trapping chip used in the particle operating method according to an embodiment of the present technology.

FIG. 6 is a schematic diagram of an example of a microchannel chip used in the particle operating method according to an embodiment of the present technology.

FIG. 7 is a schematic diagram of an example of a vibrating section.

FIG. 8 is a schematic diagram of an example of the microchannel chip used in the particle operating method according to an embodiment of the present technology.

FIG. 9 is a schematic diagram of an example of the vibrating section.

FIG. 10 is a schematic diagram of a configuration example of a particle operating system according to an embodiment of the present technology.

FIG. 11 is a schematic diagram depicting an example of a system of irradiating a particle trapping chamber with pulsed laser.

FIG. 12 is a schematic diagram depicting an example of the system of irradiating the particle trapping chamber with pulsed laser.

FIG. 13 is a photograph representing that particles have been moved by the particle operating method according to an embodiment of the present technology.

FIG. 14 is a photograph of the particles moved from inside of a well to outside of the well by the particle operating method according to an embodiment of the present technology.

FIG. 15 is a photograph representing that turbulence of a laminar flow is generated.

FIG. 16 is a photograph representing that the particles have been moved by the particle operating method according to an embodiment of the present technology.

FIG. 17 is a schematic diagram of an example of the microchannel chip used in the particle operating method according to an embodiment of the present technology.

FIG. 18 is a schematic diagram of an example of the microchannel chip used in the particle operating method according to an embodiment of the present technology.

FIG. 19 is an example of a flow chart of the particle operating method according to an embodiment of the present technology.

### DESCRIPTION OF EMBODIMENTS

Preferred embodiments for carrying out the present technology will be described below. Note that the embodiments described below are merely typical embodiments of the present technology, and the present technology is not construed in a limited manner thereby. Note that the description of the present technology will be made in the following order.

1. First Embodiment (Particle operating method)

(1) Description of First Embodiment

(2) First Example of First Embodiment (Operation of particle trapped in well)

(3) Second Example of First Embodiment (Particle operation in channel)

2. Second Embodiment (Particle trapping chip)

(1) Description of Second Embodiment

(2) First example of Second Embodiment (Chip formed from laser light-absorbing material)

(3) Second Example of Second Embodiment (Vibrating section provided on well surface or surface on opposite side)

3. Third Embodiment (Particle operating system)

(1) Description of Third Embodiment

(2) Example of Third Embodiment (Particle operating system)

4. Fourth Embodiment (Particle trapping chamber)

(1) Description of Fourth Embodiment

5. Examples

(1) Operation of Particle Trapped in Well

(2) Particle Operation in Channel

### 1. FIRST EMBODIMENT (PARTICLE OPERATING METHOD)

### (1) Description of First Embodiment

A particle operating method of the present technology includes a transport step of irradiating a vibrating section including a material that absorbs laser light (hereinafter also referred to as a “laser light absorbing material”) with the laser light in a pulsed form, to move particles by vibration generated by the irradiation. In other words, the vibrating section (particularly, the laser light absorbing material) is irradiated with the laser light in a pulsed form, whereby the vibrating section (particularly, the laser light absorbing material) is vibrated, and the particles are moved by the vibration.

The irradiation position of the laser light can be controlled at high speed and with accuracy. Therefore, the present technology makes it possible, for example, to operate many particles selectively, at high speed.

In addition, the transport step can be performed with respect to each of the plural particles. Therefore, it is possible to recover the plural particles in a predetermined order or to recover the plural particles in predetermined proportions.

Details of the particle operating method of the present technology will be described below.

(Laser Light)

In the particle operating method of the present technology, the laser light is made to perform irradiation in a pulsed form. In other words, the laser light is oscillated on a pulsed basis, instead of being oscillated continuously. The irradiation with the pulsed laser light vibrates the vibrating section, particularly the laser light absorbing material included in the vibrating section. Herein, the laser light made to perform irradiation in a pulsed form will also be referred to as a “pulsed laser.”

The laser light is preferably laser light of infrared light, and more preferably laser light of near infrared light. The infrared laser light, particularly the near infrared laser light, makes it possible to efficiently move the particles (particularly, cells) while suppressing influence on the particles.

The wavelength of the pulsed laser is, for example, 700 to 25,000 nm, preferably 800 to 2,500 nm, and more preferably 900 to 1,400 nm. By the pulsed laser having a wavelength in the above-mentioned numerical value range, the particles can efficiently be moved while influence on the particles (for example, injury of cells) is suppressed.

The pulse width of the pulsed laser is, for example, equal to or more than 1 picosecond, preferably equal to or more than 10 picoseconds, more preferably equal to or more than 100 picoseconds, and further preferably equal to or more than 500 picoseconds. In the case where the pulse width is too short (for example, on the order of femtosecond), influence may be exerted on the particles and, for example, the risk of injury of the cells increases. Where the pulse width is too short, a pulsed laser generating device would be expensive, which is undesirable from the viewpoint of cost.

The pulse width of the pulsed laser is, for example, equal to or less than 1,000 nanoseconds, preferably equal to or less than 500 nanoseconds, more preferably equal to or less than 100 nanoseconds, and further preferably equal to or less than 50 nanoseconds. In the case where the pulse width is too long, heat may be generated by the pulsed laser. The heat may have adverse influence on the particles (for example, may cause injury of cells). In addition, the heat may generate bubbles where the particles are present in a liquid. The bubbles may hamper an operation of the particles.

The repetition frequency of the pulsed laser is, for example, equal to or more than 0.01 kHz, preferably equal to or more than 0.1 kHz, more preferably equal to or more than 0.5 kHz, and further preferably equal to or more than 1 kHz. This makes it possible to generate vibration necessary for movement of the particles in a shorter period of time, and may realize a higher-speed particle operation.

The repetition frequency of the pulsed laser is, for example, equal to or less than 5,000 kHz, preferably equal to or less than 2,500 kHz, more preferably equal to or less than 2,000 kHz, still more preferably equal to or less than 1,500 kHz, yet more preferably equal to or less than 1,000 kHz, and further preferably equal to or less than 500 kHz.

The pulse energy of the pulsed laser may be set in consideration of minimum energy which may be required for movement of the particles to be operated. The pulse energy of the pulsed laser may be preferably 1.05 to 2 times the minimum energy, more preferably 1.1 to 1.5 times the minimum energy, and further preferably 1.2 to 1.3 times the minimum energy. The pulse energy in the above-mentioned numerical value range makes it possible to operate the particles efficiently from the viewpoint of energy.

The pulse energy may be set appropriately in consideration of such factors as pulse width, the area of the region to be irradiated with the laser light, absorption characteristics of the laser light absorbing material, and the kind of the material, for example.

The pulse energy of the pulsed laser may be, for example, equal to or more than 0.1 μJ, preferably equal to or more than 0.5 μJ, more preferably equal to or more than 1 μJ, and particularly preferably equal to or more than 2 μJ or equal to or more than 3 μJ. The pulse energy of the pulsed laser may be, for example, equal to or less than 1,000 μJ, preferably equal to or less than 500 μJ, more preferably equal to or less than 100 μJ, and particularly preferably equal to or less than 50 μJ.

By the pulse energy in the above-mentioned numerical value range, movement of the particles can be performed efficiently.

The pulsed layer may be outputted at a peak intensity of, for example, equal to or more than 0.1 kW, preferably equal to or more than 0.5 kW, and more preferably equal to or more than 1 kW.

The pulsed laser may be outputted at a peak intensity of, for example, equal to or less than 1,000 kW, preferably equal to or less than 500 kW, and more preferably equal to or less than 100 kW.

The pulsed laser may be outputted at an average intensity of, for example, equal to or more than 0.1 mw, preferably equal to or more than 0.5 mw, more preferably equal to or more than 1 mw, and particularly preferably equal to or more than 2 mw or equal to or more than 3 mw.

The pulsed layer may be outputted at an average intensity of, for example, equal to or less than 1,000 mw, preferably equal to or less than 500 mw, and more preferably equal to or less than 100 mw.

The number of irradiation pulses for movement of one particle may appropriately be changed according to the maximum intensity and/or the average intensity of the pulsed laser. The number of irradiation pulses for movement of one particle may be, for example, 1 to 20, preferably 1 to 15, more preferably 1 to 10, and further preferably 1 to 5. The pulse period may be, for example, 0.01 to 5 msec, preferably 0.1 to 3 msec, and more preferably 0.5 to 1.5 msec.

The pulsed laser may reach the vibrating section in a circular or elliptic beam shape. In other words, the shape of an irradiation spot of the pulsed laser is a circle or an ellipse. The irradiation spot may be formed, for example, by any optical system. The beam shape of the pulsed laser is not limited to the just-mentioned; for example, the beam shape may appropriately be set according to the object to be irradiated with the pulsed laser. Note that the circle includes substantially circular shapes, and the ellipse includes substantially elliptic shapes.

Where the beam shape is a circle, the diameter of the circle may be, for example, 0.1 to 100 μm, preferably 0.5 to 50 μm, more preferably 1 to 30 μm, and further preferably 3 to 10 μm.

Where the beam shape is an ellipse, the long diameter of the ellipse may be, for example, 0.1 to 100 μm, preferably 0.5 to 50 μm, more preferably 1 to 30 μm, and further preferably 3 to 10 μm.

In the case where the irradiation spot of the pulsed laser is too large, the possibility of causing movement of particles other than the target particles is enhanced. In the case where the region is too small, the possibility that vibration necessary for movement of the target particles may not be generated is enhanced.

The pulsed laser may be oscillated by any one of, for example, a Q switch method, a direct modulation method, an external modulation method, or a mode modulation method. The pulsed laser may preferably be a pulsed laser oscillated by the Q switch method. A pulsed laser oscillated by the Q switch method is particularly preferable from the viewpoint of energy which may be required for particle operation by the particle operating method of the present technology.

A laser light source for generating the pulsed laser may appropriately be selected by a person skilled in the art according to the kind (for example, oscillation system, wavelength, frequency, and the like) of the pulsed laser. As the laser light source, a laser light source known in the art may be used, or a commercially available laser light source may be used. The pulsed laser may be generated, for example, by a Q switch laser light source. The Q switch laser light source may be, for example, an Nd:YAG laser.

(Vibrating Section)

The vibrating section includes the laser light absorbing material. The vibrating section may at least partly include the laser light absorbing material, or may wholly include the laser light absorbing material.

The laser light absorbing material may be selected according to the kind of the laser light used for irradiation. Preferably, the laser light absorbing material is an infrared light absorbing material, and more preferably a near infrared light absorbing material. The laser light absorbing material may be a material that produces vibration capable of moving the particles by being irradiated with the pulsed laser. For example, the infrared light absorbing material may be a material that produces vibration capable of moving the particles by being irradiated with the pulsed laser of infrared light. The near infrared light absorbing material may be a material that produces vibration capable of moving the particles by being irradiated with the pulsed laser of near infrared light.

Herein, the near infrared light absorbing material may be a substance whose emissivity with respect to light of a wavelength of, for example, 1 μm (or a wavelength for practical use) is equal to or more than 0.05, more preferably equal to or more than 0.1. While an upper limit for the emissivity is not particularly limited, the near infrared light absorbing material may be a substance whose emissivity is, for example, equal to or less than 1.

According to one embodiment of the present technology, the laser light absorbing material is, for example, a resin material or a glass material that contains a laser light absorbing constituent. The resin material may be, for example, a silicone resin or a plastic resin. The silicone resin may be, for example, PDMS (polydimethylsiloxane). The plastic resin may be, for example, an acrylic resin, a cycloolefin polymer, or polystyrene. In order to form a minute shape for operation of particles, preferably, the laser light absorbing material may be a silicone resin containing a laser light absorbing constituent, more preferably PDMS containing a laser light absorbing constituent.

The laser light absorbing material is preferably transparent. With the laser light absorbing material being transparent, laser light is permitted to easily reach the laser light absorbing constituent, and vibration can be generated efficiently.

The laser light absorbing constituent may be preferably an infrared light absorbing constituent, more preferably a near infrared light absorbing constituent. The infrared light absorbing constituent (particularly, the near infrared light absorbing constituent) may be one or more constituent selected from the group including a coloring matter, carbon nanotube (CNT), metallic particles (particularly, metallic nano-particles), and precious metal particles (particularly, precious metal nano-particles).

The coloring matter may be one or more selected from indocyanine green, phthalocyanine, and porphyrin.

The metal constituting the metallic particles may be a metal whose emissivity with respect to a wavelength of, for example, 1 μm is equal to or more than 0.05, more preferably equal to or more than 0.1. The metal constituting the metallic particles may be, for example, one or more selected from the group including aluminum, brass, chromium, chromium alloys (stainless steel), cobalt, nickel, nickel alloys (for example, Inconel, monel, etc.), nichrome, iron, iron alloys (for example, steel, cast iron, etc.), lead, magnesium, molybdenum, titanium, tungsten, tin, and zinc. The metal constituting the metallic particles may be particularly preferably titanium.

The precious metal constituting the precious metal particles may be an alloy of one or more selected from the group including gold (Au), silver (Ag), platinum (Pt), palladium (Pd), rhodium (Rh), iridium (Ir), ruthenium (Ru), and osmium (Os). The precious metal constituting the precious metal particles may be particularly preferably one or more selected from the group including platinum, palladium, and rhodium.

According to another embodiment of the present technology, the laser light absorbing material may be, for example, a metal or precious metal, preferably an infrared light absorbing metal or precious metal, and more preferably a near infrared light absorbing metal or precious metal.

The metal constituting the laser light absorbing material may be the metal mentioned above as a metal constituting the metallic particles. As mentioned above, the metal constituting the laser light absorbing material may particularly preferably be titanium. The precious metal constituting the laser light absorbing material may be the precious metal mentioned above as a precious metal constituting the precious metal particles. As mentioned above, the precious metal constituting the laser light absorbing material may particularly preferably be one or more selected from the group including platinum, palladium, and rhodium.

The laser light absorbing material may be, for example, one or more selected from the group including aluminum, tungsten, and a gold-palladium alloy.

The vibration that moves the particles is generated by the laser light used for irradiation in a pulsed form. The vibration may, for example, include a thermoelastic wave, but this is not limitative.

The vibration that moves the particles may be vibration of the vibrating section itself, or may be vibration of a medium in contact with the vibrating section.

For instance, in the case where the particles are in contact with the laser light absorbing material, the laser light absorbing material is vibrated by the laser light, and the vibration may move the particles.

For example, in the case where the particles are not in contact with the laser light absorbing material, the laser light absorbing material is vibrated by the laser light, the vibration may vibrate a medium (for example, the chip described later or a material forming a channel, and/or a liquid or a gas, etc.) in contact with the laser light absorbing material, and the vibration of the medium may move the particles.

(Particles)

The particles operated by the particle operating method of the present technology may be, for example, those which may require to be operated or recovered one by one. Examples of the particles include cells, microorganisms, biologically derived solid components, biological fine particles such as liposomes, and synthetic particles such as latex beads, gel beads, magnetic beads, and quantum dots, but these are not limitative. As for the size of the particles, the maximum size (particularly, diameter) of the particles may be, for example, 3 to 200 μm, preferably 5 to 100 μm, and more preferably 5 to 50 μm.

The cells may include animal cells and plant cells. Examples of the animal cells include tumor cells and blood cells. Examples of the microorganisms include bacteria such as colibacillus and fungi such as yeast. Examples of the biologically derived solid components include solid crystals produced in living bodies.

The synthetic particles may be, for example, particles including an organic or inorganic polymeric material, a metal, or the like. The organic polymeric material may include polystyrene, styrene-divinylbenzene, and polymethyl methacrylate. The inorganic polymeric material may include glass, silica, magnetic materials, and the like. The metal may include gold colloid, alumina, and the like. In addition, in the present technology, the particles may be, for example, a bound substance of plural particles, such as two or three particles.

According to one embodiment of the present technology, the particles may be, for example, cells, microorganisms, biologically derived solid components, and biological fine particles such as liposomes, and may particularly be cells. For instance, the particle operating method of the present technology is suitable for operating cells, and, thus, may be used for operating cells. The maximum size (particularly, diameter) of the cells may be, for example, 3 to 200 μm, preferably 5 to 100 μm, and more preferably 5 to 50 μm.

In the present technology, the particles may be subjected to the particle operating method of the present technology, preferably in the state of being contained in fluid. The fluid includes liquids and gases. Preferably, the fluid is a liquid. The kind of the liquid may appropriately be selected by a person skilled in the art according to the kind of the particles. In the case where the particles are, for example, cells, there may be used, for example, water, an aqueous solution (e.g., buffer solution), or a culture medium, as the liquid.

(Transport Step)

In the transport step, particles are moved by the vibration. The particles may be moved, for example, in such a manner as to be spaced from the vibrating section, and may particularly be moved in such a manner as to be spaced from that position of the vibrating section which is irradiated with the laser light.

According to a preferred embodiment of the present technology, in the transport step, the particles may be moved in such a manner that the moving direction of the particles is changed by the vibration. For example, in the transport step, the moving direction of a particle being moved in a direction may be changed to another moving direction by the vibration. The particle whose moving direction is changed may, more specifically, be flowing in fluid, and the flowing direction of the particle may be changed by the vibration.

Note that herein the “moving direction” may be replaced with the “moving vector.” In other words, attendant on a change in the moving direction, the moving velocity may be changed.

According to a particularly preferred embodiment of the present technology, in the transport step, the particles may be moved into a predetermined moving direction by the vibration. In other words, in the transport step, the moving direction of the particles may be changed to a predetermined moving direction. In order to change the moving direction of the particles into a predetermined moving direction, for example, the vibration may preferably have directivity. With the particles operated according to this embodiment, the particles may be moved into a desired moving direction.

According to another preferred embodiment of the present technology, in the transport step, the particle may be moved from a predetermined place by the vibration. The particle thus moved may, for example, stand still at a predetermined place, and the still particle may be moved by the vibration. More specifically, the particle may be present in fluid, and may start being moved in a moving direction, particularly in a predetermined direction, in the fluid by the vibration.

The transport step may preferably be performed on the particles present in a closed space. Since the particles in the closed space can be moved in the transport step, the particles can be recovered without a risk of contamination, for example.

The “closed space” herein refers to a space into which fluid may not penetrate through parts other than a preliminarily connected channel. Light may get access to the inside of the closed space, and particularly, light may get access to the vibrating section provided in the closed space.

Examples of the closed space include a space in a particle trapping chamber, which will be described below, and a space in a microchannel, but these are not limitative.

In the transport step, the particles may be moved in various patterns.

For example, in the transport step, the particles in a non-flowing fluid may be moved into a flowing fluid, or the particles in a flowing fluid may be moved into a non-flowing fluid.

For instance, in the transport step, the particles in a flowing fluid may be moved into another flowing fluid, or the particles in a non-flowing fluid may be moved into another non-flowing fluid.

According to a preferred embodiment of the present technology, in the transport step, the moving direction of a particle may be changed according to the kind of the particle. The kind of the particle may be specified, for example, in an analysis step described below. With the moving direction being changed according to the kind of the particle, it is, for example, possible to perform a particle isolating operation of isolating a predetermined kind of particles and discarding other kinds of particles. In the particle isolating operation, one kind of particles may be isolated, or two or more kinds of particles may be isolated. In the case where two or more kinds of particles are isolated, in the transport step, the two or more kinds of particles may all be moved in the same moving direction, or the two or more kinds of particles may be moved in different directions according to the kinds of the particles.

According to one embodiment of the present technology, in the transport step, particles standing still may be moved. For example, particles standing still in a non-flowing fluid may be moved into a flowing fluid.

More specifically, in the transport step, by the vibration, particles present in a well on a substrate (particles present in a non-flowing fluid) may be moved into a flowing fluid. As a result, by the present technology, the particles in the well may be moved into a flowing fluid, thereby being moved into another space (e.g., a predetermined recovery vessel or the like). An example of this will be described in (2) below.

According to another embodiment of the present technology, in the transport step, the vibration may be used for changing the direction or velocity of movement of the particles being moved. For example, particles flowing in a fluid flowing in a going direction may be moved into a fluid flowing in another going direction.

More specifically, in the transport step, particles in one of two laminar flows going in different directions may be moved into the other laminar flow. An example of this will be described in (3) below.

(Other Steps which May be Included in Particle Operating Method of Present Technology)

The particle operating method of the present technology may include other steps, in addition to the transport step. Examples of the other steps include an interval adjustment step, an analysis step, and a recovery step.

An example of a flow chart of the particle operating method of the present technology is depicted in FIG. 19. As illustrated in FIG. 19, the particle operating method of the present technology may include, for example, an interval adjustment step S101, an analysis step S102, the transport step S103, and a recovery step S104. As a result, from among plural particles (for example, cells), one particle (e.g., cell) having a desired characteristic can selectively be recovered.

The transport step of step S103 is as described above. The interval adjustment step of step S101, the analysis step of step S102, and the recovery step of step S104 will be described below.

(Interval Adjustment Step S101)

The particle operating method of the present technology may include an interval adjustment step of adjusting the interval between particles of plural particles. In the interval adjustment step, for example, the plural particles may be disposed with intervals therebetween, or may be made to flow with intervals therebetween. After the interval between the plural particles is adjusted, the transport step may be carried out. In the interval adjustment step, the interval between the particles is adjusted, whereby in the transport step, it is possible to prevent irradiation with pulsed laser for moving one particle from moving another particle. The interval may appropriately be set according to, for example, such factors as the intensity of the pulsed laser and the particle size.

In the case where the plural particles are disposed with intervals therebetween in the interval adjustment step, for example, the plural particles may be disposed on a substrate with intervals therebetween. More specifically, plural wells may be provided on the substrate with intervals therebetween, and one particle may be trapped in each of the plural wells in the interval adjustment step. As a result, the plural particles may be disposed with intervals therebetween. In (2) below, an example in which one particle is trapped in each of the wells in the interval adjustment step will be described. In the case where the particles are trapped in the wells in the interval adjustment step, the step may also be referred to as a particle trapping step.

Note that the plural wells may not necessarily be provided on the substrate, insofar as the particles are disposed with intervals therebetween. For example, particle trapping substances may be disposed with intervals therebetween on the substrate, and, by binding of one particle to each of the particle trapping substances, the plurality of particles may be disposed with intervals therebetween.

In the case where the plural particles are made to flow with intervals therebetween in the interval adjustment step, for example, the plural particles may flow in a channel. For instance, in the interval adjustment step, for example, plural particles may flow with intervals therebetween in a laminar flow that flows in a channel. An example in which plural particles flow with intervals therebetween in a channel in the interval adjustment step will be described in (3) below. In the case where the particles are made to flow in the interval adjustment step, the step may also be referred to as a conduction step.

(Analysis Step S102)

The particle operating method of the present technology may include an analysis step of analyzing a particle. The analysis step may be carried out, for example, after the interval between the particles is adjusted in the interval adjustment step. In the analysis step, the particle to be moved in the transport step is selected. Then, the selected particle is moved in the transport step.

The analysis step may include, for example, a treatment step of chemically or physically treating the particle. The treatment may be, for example, a treatment for permitting easy selection of the particle to be moved.

In the case where the particles are cells, for example, the chemical treatment may be a treatment of a cell with a reagent (for example, an enzyme, a fluorescent substance, etc.), a treatment of binding of a cell binding substance (for example, an antibody, a nucleic acid, etc.) with a cell, or a treatment of binding between a cell and a cell.

In the case where the particles are cells, for example, the physical treatment may be a treatment of irradiation with electromagnetic waves (for example, UV rays, visible rays, infrared rays, or radioactive rays), heat treatment (heating treatment or cooling treatment), or the like.

The treatment step may be carried out, for example, in the case where one particle is trapped by each of plural wells in the interval adjustment step.

The analysis step may include, for example, an observation step and/or a detection step.

In the observation step, the particles may be observed, for example, through a microscope. In the observation step, for example, the shape, the size, or the color of the particles may be observed. In the detection step, for example, alternatively, fluorescence emitted by the particles may be detected, for example, by a light detector. In the analysis step, for example, on the basis of the observation results in the observation step and/or the detection results in the detection step, the particle to be operated in the transport step may be selected.

The analysis step including the observation step and/or the detection step may be carried out, for example, in the case where one particle is trapped in each of plural wells in the interval adjustment step.

In the analysis step, the plural particles may be analyzed, for example, by a combination of a light irradiation device and a light detection device. Each of the plural particles may be irradiated with light by the light irradiation device, and, on the basis of fluorescence and/or scattered light generated by the irradiation, the particle to be operated in the transport step may be selected.

The analysis by the combination may be carried out, for example, in the case where the plural particles are made to flow with intervals therebetween in the interval adjustment step.

(Recovery Step S104)

The particle operating method of the present technology may include a recovery step of recovering the particles moved in the transport step.

Since only the selected particles can be moved in the transport step, only the particles selected in the analysis step can be moved and recovered. For example, the particles moved in the transport step are guided, for example, into a particle recovery channel in the recovery step.

Alternatively, only the particles selected in the analysis step may be moved and discarded. For example, the particles moved in the transport step may not be recovered in the recovery step, and may be guided, for example, to a discarding channel.

In the recovery step, for example, one particle or plural particles may be recovered into one vessel or compartment. Alternatively, in the recovery step, one or plural particles may be recovered into each of plural vessels or compartments.

In the recovery step, for example, 1 to 1,000,000 particles, particularly 5 to 500,000 particles, and more particularly 10 to 100,000 particles may be recovered, but the number of the particles to be recovered may appropriately be selected by a person skilled in the art or according to the purpose. In the particle operating method of the present technology, the period of time which may be required for moving one cell can be made very short, and, therefore, many cells can be recovered at high speed. In the recovery step, plural particles may be recovered dividedly in plural groups (for example, 2 to 20 groups, and particularly 2 to 10 groups). For example, 1,000 to 100,000 particles may be recovered dividedly in 2 to 20 groups, particularly in 2 to 10 groups.

### (2) First Example of First Embodiment (Operation of Particle Trapped in Well)

(2-1) Description of Related Art (Particle Trapping Chamber)

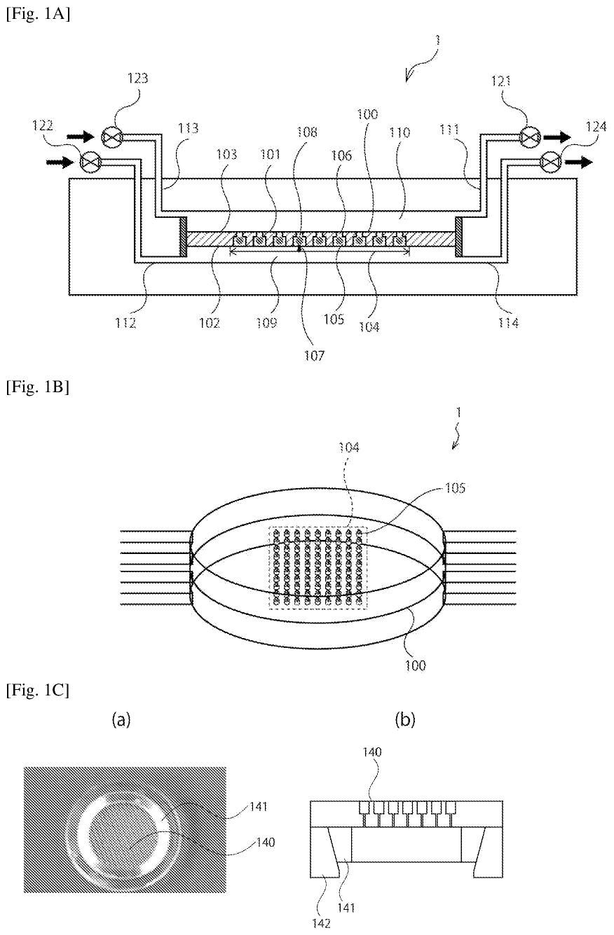

First, an example of a particle trapping chamber used in the particle operating method of the present technology will be described below referring to FIGS. 1A and 1B.

A particle trapping chamber 1 depicted in FIGS. 1A and 1B includes a particle trapping chip 100 in the inside thereof, and the particle trapping chip 100 partitions the inside of the chamber 1 into two spaces. The particle trapping chip 100 includes a substrate 101. The substrate 101 includes a particle trapping surface 102 and a surface 103 directed to the side opposite thereto. The particle trapping surface 102 is provided with a particle trapping region 104, and the particle trapping region 104 includes plural wells 105. The well 105 has such a size that the particle can be accommodated in the inside thereof. Each of the wells 105 is provided with a hole 106 in a bottom portion thereof. The hole 106 penetrates from the bottom portion of the well to the surface 103 on the side opposite to the particle trapping surface 102. The hole 106 has such a size that the particle is not passed therethrough.

According to a preferred embodiment of the present technology, the particle trapping region 104 may be surrounded by a reinforcement member. By the reinforcement member, for example, uniform tension can be given to the whole body of the particle trapping region 104, and the particle trapping region 104 can be prevented from being flexed. With the flexure prevented, at the time of observing the particle in the well under a microscope, the number of times of a focal depth adjusting operation on a particle basis can be reduced, or the adjusting operation can be unnecessitated. In addition, with the flexure prevented, accuracy of an irradiation position of pulsed laser can be enhanced.

The reinforcement member may preferably has such a size as to be able to surround the periphery of the particle trapping region 104. For example, in the case where the particle trapping region 104 is rectangular in shape, the reinforcement member may have such a shape as to be able to surround the rectangle (particularly, a rectangular shape). Besides, in the case where the particle trapping region 104 is circular in shape, the reinforcement member may have such a shape as to be able to surround the circle (particularly, a circular shape).

The reinforcement member may include a rigid material, and may include a material unsusceptible to dimensional change, such as, for example, a metal. For example, the reinforcement member may be a metallic ring. According to one embodiment of the present technology, the particle trapping region 104 may include a silicone resin (e.g., PDMS or the like), and the reinforcement member surrounding the particle trapping region 104 may include a metal. Such a configuration makes it possible to apply tension from the center of the particle trapping region 104 toward the reinforcement member, and to thereby improve flatness of the particle trapping region 104. FIG. 1C depicts, in (a), a photograph of an example of the particle trapping region surrounded by the reinforcement member. In FIG. 1C (a), a circular particle trapping region 140 include a silicone resin is surrounded by a circular metallic ring 141 larger than the region. FIG. 1C depicts, in (b), a schematic diagram of a section of the particle trapping region surrounded by the reinforcement member. As illustrated in FIG. 1C (b), the particle trapping region 104 may be circular with a diameter of 6 mm, for example. The inside diameter of the metallic ring 141 may be, for example, 6 mm, and the outside diameter thereof may be, for example, 8 mm, so that the width of the metallic ring 141 may be, for example, 1 mm. A frame 142 may be formed in the periphery of the particle trapping region 140. By the frame 142, the position of the metallic ring 141 may be fixed. The frame 142 may be inclined at the inner side thereof, as depicted, for example, in FIG. 1C (b). By the inclination, the metallic ring 141 can be prevented from being separated from the particle trapping region 140.

The particle trapping chamber 1 is disposed such that gravity acts on the particle 108 in the direction of an arrow 107. In other words, the particle 108 settles in the direction of the arrow 107. In view of this, of the two spaces partitioned by the particle trapping chip 100, the space on the lower side will be referred to as a space 109 on the particle setting side, while the space on the upper side will be referred to as a space 110 on the opposite side of the space on the settling side.

Note that the particle trapping chamber 1 may be disposed vertically inversely (in other words, such that the wells are directed to the side opposite to the acting direction of gravity).

The particle trapping chamber 1 includes a suction channel section 111, a first fluid supply channel section 112, a second fluid supply channel section 113, and a fluid discharge channel section 114. The suction channel section 111 and the second fluid supply channel section 113 are connected to the space 110 on the opposite side. The first fluid supply channel section 112 and the fluid discharge channel section 114 are connected to the space 109 on the settling side.

Into the inside of the particle trapping chamber 1, fluid can penetrate only from these preliminarily connected four channels; in other words, the inside of the particle trapping chamber 1 is a closed space.

The suction channel section 111, the first fluid supply channel section 112, the second fluid channel section 113, and the fluid discharge channel section 114 are provided with valves 121, 122, 123, and 124, respectively.

Note that FIG. 1 is a schematic diagram of an example of a state in which particles are trapped in the wells 105, and the particles may not necessarily be present in the wells 105 before a particle trapping treatment.

In order to take out only the particles having a desired characteristic from the particles trapped in the wells 105, for example, use of the aforementioned micromanipulator may be considered.

However, recovery of particles by the micromanipulator takes time. For example, the recovery may include suction of particles (for example, cells) by a capillary, reciprocation between the position of the capillary at the time of suction of the particles and the position of the capillary at the time of ejection of the particles, ejection of the particles, and cleaning of the capillary. Therefore, huge time may be needed for recovering many particles.

In addition, for the recovery of the particles by the micromanipulator, the capillary should penetrate into the particle trapping chamber 1, and, for example, part of an outer wall of the particle trapping chamber 1 should be opened. Therefore, the space inside the chamber and the space outside the chamber make contact with each other, which contact may cause contamination. Besides, in the case where the wells are directed in the acting direction of gravity, as in the particle trapping chamber 1, the capillary should reach the well from the lower side of the chamber, but this may be extremely difficult to achieve.

In order to take out only the particles having a desired characteristic from among the particles trapped in the wells 105, for example, use of the aforementioned optical tweezers effect or a bubble may be considered.

However, a force exerted on the particle by the optical tweezers effect is generally considered to be on the piconewton order. The force is not sufficient for rapidly moving the particle, and moreover, the force may not able to overcome an interaction (for example, an interaction caused by an intermolecular force or an electrostatic force) of the particle with an inner wall of the well 105. In addition, the particle operation by the optical tweezers effect may need a lot of time. For example, in the aforementioned NPL 1, 5 seconds or more is taken for taking out one MCF 7 cell having a diameter of approximately 15 μm from a well having a diameter of 30 μm and a depth of 35 μm. Therefore, it is considered that huge time may be needed for recovering many particles.

Besides, in order to move the particle by the bubble, a special configuration for generating the bubble may be required to be introduced to the particle trapping chamber 1, which may lead to increased cost and worsened productivity. In addition, the introduction of the configuration for generating the bubble in the vicinity of the well 105 may reduce the number of the wells 105.

(2-2) Application Example of Present Technology

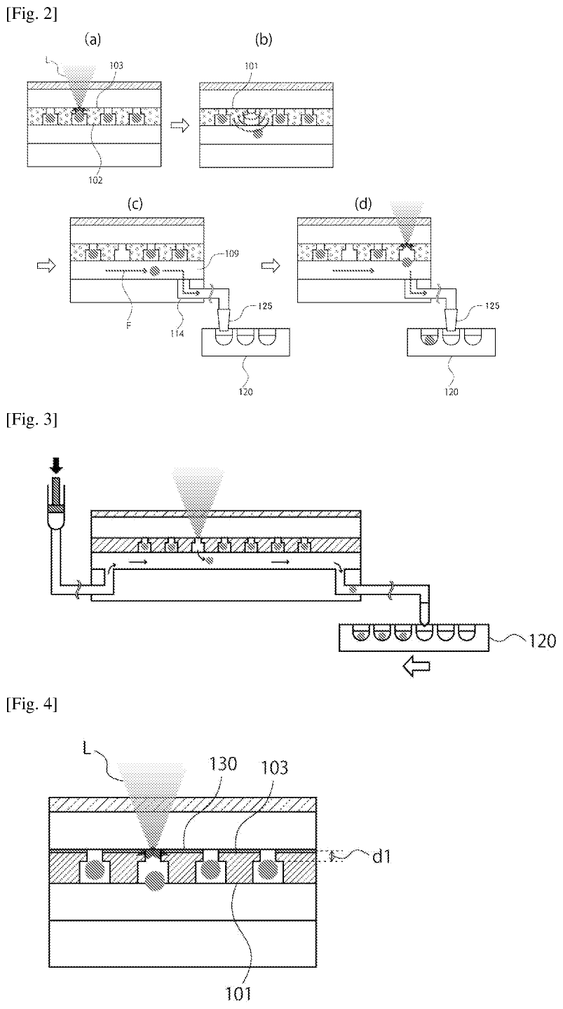

An example of operating the particle trapped in the well 105 of the above-described particle trapping chamber 1 by the particle operating method of the present technology will be described below referring to FIG. 2.

(2-2-1) Configuration Example of Particle Trapping Chamber Used for Particle Operating Method of Present Technology

The particle trapping chamber used in the particle operating method of the present technology may be the same as the particle trapping chamber 1 described in (2-1) above, except that the vibrating section is introduced. FIG. 2 is a diagram for explaining an operation of a particle trapped in the well 105 of the particle trapping chamber 1, and is a diagram in an enlarged form of the vicinity of the well 105 in the particle trapping region 104 illustrated in FIG. 1.

For carrying out the particle operating method of the present technology, the substrate 101 may include a vibrating section. For example, for performing the particle operating method of the present technology, the substrate 101 constituting the particle trapping chip 100 may include a material containing a constituent that absorbs laser light. The substrate 101 as a whole includes a laser light absorbing material; in other words, the substrate 101 as a whole is the vibrating section in the present technology. While the substrate 101 as a whole includes a laser light absorbing material in the present application example, only the particle trapping region 104 of the substrate 101 may include a laser light absorbing material, or only the periphery of the wells 105 may include a laser light absorbing material.

The constituent that absorbs laser light may preferably be one that absorbs infrared laser light, more preferably one that absorbs near infrared laser light. The constituent may be, for example, one or more constituents selected from the group including a coloring matter such as indocyanine green, phthalocyanine, and porphyrin, carbon nanotube (CNT), and precious metal nanoparticles. The constituent is preferably dispersed uniformly in the above-mentioned material.

The material containing the constituent may include, for example, a material generally used in the technical field concerning microchannel. Examples of the material include: glasses such as borosilicate glass and quartz glass; plastic resins such as acrylic resin, cycloolefin polymers, and polystyrene; rubber materials; and silicone resins such as PDMS. The material may preferably be any one of these materials, more preferably a silicone resin, for example, PDMS.

At least one of the plural wells 105 in the particle trapping region 104 may be provided with a mark. The mark may be, for example, a mark to be referred to for specifying the coordinates of each well. The mark makes it easy to specify the position of the well where a target particle is trapped, in the analysis step which will be described below. In addition, the mark make it easy to specify the position where irradiation with pulsed laser is conducted, in the transport step which will be described below. The mark may be visually checkable, or may be detectable by a mark detection device (for example, an imaging device and/or an image processing device). Such a mark may be, for example, a character, a pattern, or a labeling substance (for example, a fluorescent label), or may have a well shape (for example, only the marked well is circular whereas the other wells are rectangular in shape).

(2-2-2) Example of Particle Operation

(Particle Trapping Step)

As has been described in (2-1) above, one particle is trapped in each of the wells 105 in the particle trapping region 104 by suction. As a result, the particles are disposed with a predetermined interval (the interval of the wells) therebetween.

(Analysis Step)

After the particle trapping step, the particles trapped in the wells are analyzed. As a result of the analysis in the analysis step, the particle to be moved is selected.

The analysis is carried out, for example, by a microscope. The observation of the particle by use of the microscope may be performed, for example, from the lower side of the particle trapping chamber 1; in other words, the particle may be observed from the settling side of the particle. In this case, the microscope may be, for example, an inverted microscope, and the observation may be performed through an objective lens of the inverted microscope. The observation may be, for example, bright field observation or fluorescence observation. In these kinds of observation, change of the particle with time may be observed.

In the case where the particle trapping chamber 1 is disposed vertically inversely, an upright microscope may be used as the microscope.

(Transport Step)

The particles selected in the analysis step are moved in the transport step. As depicted in FIG. 2 (a), in the transport step, the well in which the selected particle is trapped is irradiated with a pulsed laser L of near infrared light. Irradiation with the pulsed laser L is preferably conducted toward the surface 103 on the opposite side of the particle trapping surface 102. Particularly preferably, the irradiation with the pulsed laser L is conducted such that the pulsed laser L is converged onto that part of the surface 103 which corresponds to the well in which the selected particle is trapped (for example, such that the pulsed laser L is converged onto the vicinity of a hole of the well). The details of the pulsed laser L are as described in (1) above.

By the irradiation with the pulsed laser, vibration is generated in the substrate 101, as depicted in FIG. 2(b). The vibration is considered to include, for example, a thermoelastic wave. By the vibration, the particle present in the well is moved to the outside of the well.

In the transport step, since the particle is trapped in each of the wells in the substrate, the vibration generated in the case where the well containing the selected particle is irradiated with the pulsed laser can restrain the particles trapped in other wells from being moved. In other words, a wall defining the well may act as a barrier for preventing the vibration from being propagated to the other wells. For example, unless irradiation with pulsed laser having a pulse energy greatly exceeding the pulse energy necessary for driving one particle away from the well (for example, a pulse energy of 5 to 10 times the proper pulse energy) is conducted, the particle in the well adjacent to the well in which the selected particle is trapped would not substantially fly out of the well.

The irradiation spot of the pulsed laser is preferably circular or elliptic in shape.

The diameter of the circle or the long diameter of the ellipse may be set from the viewpoint of well pitch. For example, the diameter of the circle or the long diameter of the ellipse may preferably be equal to or less than ½ times of the well pitch, more preferably equal to or less than ⅓ times the well pitch.

The well pitch may be, for example, 30 to 100 μm, preferably 40 to 80 μm. The wells may be disposed, for example, in a grid pattern.

The diameter of the circle or the long diameter of the ellipse may be set from the viewpoint of the size of the well. In the case where the well is circular or rectangular, for example, the diameter or long diameter of the irradiation spot may preferably be equal to or less than the diameter or one side of the well, more preferably be equal to or less than ⅔ times the diameter or one side of the well, and further preferably equal to or less than ½ times the diameter or one side of the well.

By the irradiation spot of this size, the particles in the wells other than the selected well are restrained from being moved.

In the transport step, irradiation with the pulsed laser may be conducted, for example, while the suction through the hole is being performed, or may be conducted without the suction being performed. By controlling both the adjustment of the suction pressure and laser irradiation conditions, movement of particles other than the selected particle can be restrained more securely, or the moving speed can be adjusted.

In the transport step, one particle is moved from the inside of the well in which the particle is trapped to the outside of the well in, for example, 0.5 to 10 msec, preferably 1 to 8 msec, and more preferably 1 to 5 msec. The period of time necessary for moving one particle in the transport step is thus very short. Therefore, for example, even when many particles are all moved sequentially, the period of time which may be required for the movements is short.

(Recovery Step)

The particle operating method of the present technology may further include a recovery step of recovering the particle moved to the outside of the well. As depicted in FIG. 2(c), the particle moved to the outside of the well flows toward the fluid discharge channel section 114 due to a flow F formed in the space 109 on the settling side. The flow may be formed, for example, by the supply of a liquid (particularly, a liquid not containing particles) from the first fluid supply channel section 112 and the suction through the fluid discharge channel section 114. For example, a microplate 120 is provided at an end point of the fluid discharge channel section 114, and the particle is recovered into one well in the microplate via a nozzle 125 provided at the end point of the fluid discharge channel section 114, as illustrated in FIG. 2 (d). The microplate 120 may be a commercially available microplate.

In FIG. 2(d), the operations in FIG. 2(a) to (c) are repeated. Note that the particle driven out of the well in FIG. 2(d) may be recovered into a well different from the well in which the particle has already been recovered, or may be recovered into the same well as the well in which the particle has already been recovered. In the recovery step, the well into which the particle is to be recovered may be changed by movement of the nozzle 125.

Alternatively, as illustrated in FIG. 3, the well into which the particle is to be recovered may be changed by movement of the microplate 120 or a stage (not illustrated) on which the microplate 120 is mounted.

In this way, by repeating the operations in FIG. 2 (a) to (c) multiple times, many particles can be recovered at high speed and selectively.

For confirming that the particle has been recovered into each well in the microplate 120, for example, a particle detection device may be used. The particle detection device may detect that the particle has been recovered into each well by, for example, fluorescence detection. After it is confirmed by the particle detection device that the particle has been recovered into each well, the nozzle 121 is moved or the micro 120 is moved, whereby selective recovery of the particles can be performed more securely.

For the fluorescence detection, in the analysis step, a label (for example, a fluorescent label) for specifying the position of the well may be imparted to the particle trapped in the well in the particle trapping chamber 1. The label makes it possible to check whether or not a target cell has been recovered into the well in the microplate 120.

In the recovery step, for example, one particle each may be recovered or plural particles may be recovered, into each well in the microplate 120.

For example, in the recovery step, a cell population including a plurality of kinds of cells may be classified into N kinds of cell groups. Here, N is an integer equal to or more than 2, and may be, for example, 2 to 100, particularly 2 to 50, and more particularly 2 to 30.

For performing the classification, only the cells belonging to a first cell group may selectively be recovered into one cell, only the cells belonging to a second cell group may next be recovered selectively into another cell, and this recovering operation may be repeated until only the cells belonging to a final N-th cell group are selectively recovered into one well.

The respective recoveries of the cell groups may be conducted through the same fluid discharge channel section, or may be performed through plural different fluid discharge channel sections. In the latter case, the plural different fluid discharge channel sections may be provided respectively with valves, and, by controlling the opening/closing of the valves, switching of the fluid discharge channel sections for recovery of the particles may be performed.

As described above, the particles moved in the transport step of the particle operating method of the present technology are preferably present in the wells on the substrate. As a result, it is possible to prevent the irradiation with the pulsed laser for moving the selected particles from moving the non-selected particles.

(2-3) Modification 1

The particle trapping chamber 1 described in (2-2) above has a configuration in which the substrate 101 as a whole includes a laser light absorbing material. In order to perform the particle operating method of the present technology, however, a vibrating section may be provided on a surface of the substrate 101. The vibrating section may be, for example, a layer (thin film) of a laser light absorbing material provided on the surface of the substrate 101. This example will be described referring to FIG. 4.

As illustrated in FIG. 4, for example, a vibrating section (a layer of a laser light absorbing material) 130 may be provided on a surface 103 (that is, a surface not formed with the wells) of the substrate 101. In this case, as in the description regarding the transport step in (2-2-2) above, with the surface 103 irradiated with the pulsed laser L, particularly with the irradiation with the pulsed laser L conducted such that the pulsed laser L is converged onto that part of the surface 103 which corresponds to the well in which the selected particle is trapped, the particle is moved from the inside of the well to the outside of the well.

In this modification, the particle is not in direct contact with the vibrating section 130. In this modification, the vibration of the vibrating section 130 caused by irradiation with the pulsed laser is propagated to the substrate 101, and the substrate 101 vibrated by the propagation moves the particle from the inside of the well to the outside of the well.

In this modification, the thickness d1 from the well bottom portion to the surface 103 may be, for example, equal to or less than 30 μm, preferably equal to or less than 20 μm. The thickness d1 may be, for example, equal to or more than 3 μm, preferably equal to or more than 5 μm. With the thickness set within the numerical value range, the vibration generated in the vibrating section 130 is easily transmitted to the particle in the well, and more efficient movement of the particle is permitted.

Note that in this case, the thickness of the substrate 101 may be, for example, 20 to 100 μm, preferably 30 to 80 μm, and more preferably on the order of 50 μm.

In this modification, the vibrating section may be formed, for example, by coating, or may be formed by a micro-contact printing method, or may be formed by sputtering or vapor deposition.

The formation of the vibrating section by coating may be carried out, for example, by applying a liquid laser light absorbing material to the substrate, and curing the material. The liquid laser light absorbing material may be, for example, a silicone resin or a plastic resin that contains the above-mentioned near infrared light absorbing constituent. The curing may be conducted by a technique known in this technical field, and may be, for example, curing by irradiation with light (particularly, UV rays) or curing by heating.

In addition, by the micro-contact printing method, a layer of the laser light absorbing material may be formed on only that part of the surface 103 of the substrate 101 which is irradiated with the pulsed laser (for example, only the well parts).

Besides, by the sputtering or the vapor deposition, for example, a near infrared light absorbing metallic thin film of aluminum, tungsten, or the like may be formed on the surface 103 of the substrate 101.

In this modification, the vibrating section does not make direct contact with the particle. Therefore, influence of the material contained in the vibrating section on the particle can be reduced. For example, in the case where the particles are cells, the influence of the vibrating section on the cells can be reduced, and, for example, the risk of contamination can be reduced. In addition, in this modification, the demand for the accuracy of the position of the irradiation spot of the pulsed laser is mitigated.

(2-4) Modification 2

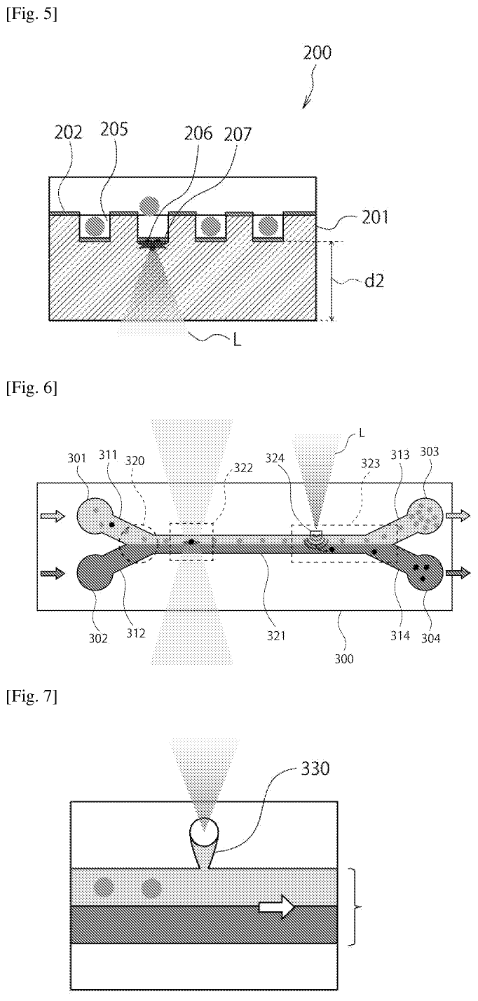

In the particle trapping chamber 1 described in (2-2) above, each well has a hole for suction. The particle operating method of the present technology may be applied to the particle trapped in a well not having the hole (particularly, a well which does not have the hole and which is opening toward the side opposite to the acting direction of gravity). In this example, the thickness of the particle trapping chip may be, for example, in excess of 50 μm. This example will be described below referring to FIG. 5.

First, the configuration of a particle trapping chip used in this modification will be described.

A particle trapping chip 200 illustrated in FIG. 5 includes a substrate 201. The substrate 201 includes plural wells 205 in a particle trapping surface 202 thereof. The well 205 has such a size as to be able to accommodate a particle in the inside thereof. A vibrating section 207 is formed at a bottom portion 206 of the well 205. The vibrating section 207 may be, for example, a near infrared light absorbing metallic thin film of aluminum, tungsten, or the like. The metallic thin film may be formed by sputtering or vapor deposition. Note that attendant on the formation of the metallic thin film at the well bottom portions by sputtering or vapor deposition, the metallic thin film may be formed at parts other than the wells 205.

The substrate 201 is transparent, and near infrared light made to perform irradiation from the lower side of the paper surface can be transmitted through the substrate to reach the vibrating section 207.

Next, particle trapping and particle movement by use of the particle trapping chip will be described.

The particle trapping chip 200 is disposed such that the wells 205 open toward the side opposite to the acting direction of gravity. Therefore, the particle enters the well 205 by settling.

As depicted in FIG. 5, the vibrating section 207 is irradiated with pulsed laser L of near infrared light from the lower side of the paper surface. As a result, the vibrating section 207 is vibrated. By the vibration, the particle is moved from the inside of the well to the outside of the well.

The particle moved to the outside of the well may, for example, be recovered by a flow formed in a space with which the particle trapping surface 202 makes contact. The recovery may be conducted, for example, similarly to that in the recovery step described in (2-2) above.

In this modification, the distance d2 from the well bottom portion to the surface on the opposite side of the particle trapping surface may be several millimeters. Therefore, in the case where the substrate forming material itself does not contain a laser light absorbing constituent, the vibrating section may be provided at the particle trapping surface. The pulsed laser may be transmitted through the substrate, from the surface on the opposite side of the particle trapping chip, and be converged onto the vibrating section provided at the well bottom surface. In this case, most part (at least a central part) of the converged spot should be positioned in the inside of the particle trapping chip and the inside of the well, and the demand for the accuracy of pulsed laser irradiation position is enhanced.

In addition, at the time of forming a surface layer on a rugged surface of the well, a coating method is difficult to carry out, and, therefore, the production method is limited. Note that, even in this modification, if the distance d2 is, for example, on the order of 50 μm or less, the vibrating section may be provided at the surface on the opposite side. By this, the above-mentioned problem is solved.

The particle operating method of the present technology may be used not only for moving the particle trapped in the well opening in the acting direction of gravity or the well opening in the opposite direction thereof but also for moving the particle trapped in the well opening in another direction.

In the present technology, preferably, the particle is trapped into the well by the suction through the hole provided in the well. The trapping of the particle into the well by the suction is applicable to both the case where the well is opening in the acting direction of gravity and the case where the well is opening toward the opposite side, whereby the degree of freedom in the configurations of devices in which the particle operating method of the present technology is used or the particle trapping chip is enhanced more. For example, the microscope for particle observation may be an upright microscope or may be an inverted microscope.

(2-5) Modification 3

In the particle operating method of the present technology, a particle adhering to that part of the particle trapping chip which is outside the well may be moved. For example, at the time of trapping the particle into the well, the particle operating method of the present technology may be applied for removing an unrequired particle or impurities adhering to that part of the chip surface which is outside the well. By this, the chip surface can be cleaned. Even in the case where the chip surface is cleaned by a liquid flow, the flow velocity is substantially zero on the chip surface, and particularly a sticky substance is not easy to remove from the chip surface. With the particle floated from the chip surface into the liquid by the particle operating method of the present technology, the particle can easily be discharged by a liquid flow.

### (3) Second Example of First Embodiment (Particle Operation in Channel)

(3-1) Application Example of Present Technology

The particle operating method of the present technology may be used for moving a particle present in a microfluidic structure of a microfluidic device such as a channel or a well. For example, the particle operating method of the present technology may move the particle present in the channel by vibration. The channel may be one that has such a size that a particle can flow therethrough, and may be, for example, a channel used in the technical field of microchannel. For example, a side surface of the channel may include the vibrating section. Plural laminar flows may be formed in the channel, and the particle may be moved from one laminar flow into another laminar flow by the vibration.

An example of operating a particle flowing in a channel by the particle operating method of the present technology will be described below referring to FIG. 6.

(3-1-1) Configuration Example of Microchannel Chip Used in Particle Operating Method of Present Technology

FIG. 6 depicts an example of a microchannel chip for isolating a particle having a specified characteristic from plural particles. A microchannel chip 300 illustrated in FIG. 6 includes a first inlet 301 through which a particle-containing liquid is introduced, a first channel 311 in which the liquid introduced via the first inlet 301 flows, a second inlet 302 through which a non-particle-containing liquid is introduced, and a second channel 312 in which the liquid introduced via the second inlet 302 flows.

The microchannel chip 300 has a confluence section 320 where the first channel 311 and the second channel 312 join each other.

The microchannel chip 300 further has an isolation determining channel 321 in which fluid joined at the confluence section 320 flows.

The isolation determining channel 321 is provided with an isolation determining region 322 and an isolating region 323. In the isolation determining region 322, it is determined whether or not a particle is to be isolated. In the isolating region 323, isolation based on the results of the determination is conducted.

In the isolating region 323, the isolation determining channel 321 is branched into a third channel 313 and a fourth channel 314. A first outlet 303 is provided at a terminal end of the third channel 313, and fluid may be discharged through the outlet to the outside of the microchannel chip 300. A second outlet 304 is provided at a terminal end of the fourth channel 314, and fluid may be discharged also through the outlet to the outside of the microchannel chip 300.

Into the isolation determining channel 321, fluid can penetrate only through the first channel 311, the second channel 312, the third channel 313, and the fourth channel 314 which are preliminarily connected to the isolation determining channel 321; in other words, the inside of the isolation determining channel 321 is a closed space.

(3-1-2) Example of Particle Operation

(Conduction Step)

The particle-containing liquid is introduced via the first inlet 301. The particle-containing liquid flows in the first channel 311 in a laminar flow state toward the confluence section 320. The plural particles contained in the particle-containing liquid flow with intervals therebetween in the first channel 311.

The non-particle-containing liquid is introduced via the second inlet 302. The non-particle-containing liquid flows in the second channel 312 in a laminar flow state toward the confluence section 320.

At the confluence section 320, the particle-containing liquid and the non-particle-containing liquid join each other. These two liquids are not mixed with each other, and flow as two layers of liquid in the isolation determining channel 321 toward the isolating region 323. In the isolation determining channel 321, also, the plural particles contained in the particle-containing liquid flow with intervals therebetween.

(Analysis Step)

According to one embodiment of the present technology, the particles in the particle-containing liquid are irradiated with light in the isolation determining region 322. On the basis of fluorescence and/or scattered light generated by the irradiation with light, it is determined whether or not the going direction of the particle is to be changed. The determination may be conducted on the basis of whether or not the fluorescence and/or scattered light generated by the irradiation satisfies a predetermined criterion.

For isolation determination in the isolation determining region 322, a light irradiation device and a detection device (both not illustrated) may be used. The isolation determination using the light irradiation device and the detection device may be conducted similarly to isolation determination conducted, for example, in a flow cytometer.

The light irradiation device performs irradiation with light in the isolation determining region 322. The light irradiation device may include, for example, a light source that emits light, and an objective lens that converges excited light onto the particle flowing in the isolation determining region. The light source may be selected appropriately by a person skilled in the art according to the purpose of analysis, and may, for example, be a laser diode, an SHG laser, a solid-state laser, a gas laser, or a high-luminance LED or a combination of two or more of them. The light irradiation device may include other optical elements, as appropriate, in addition to the light source and the objective lens. As the light irradiation device, a device known in this technical field or a device commercially available may be used.

The detection device detects scattered light and/or fluorescence generated from the particle by irradiation with light by the light irradiation device. The detection device may include a condenser lens for converging the fluorescence and/or scattered light generated from the particle, and a detector. As the detector, there may be used a PMT, a photodiode, a CCD, or a CMOS, but these are non-limitative. The detection device may include other optical elements, as appropriate, in addition to the condenser lens and the detector. The detection device may further include, for example, a spectroscopic section. As an optical part constituting the spectroscopic section, there may be mentioned, for example, a grating, a prism, and an optical filter. The spectroscopic section ensures, for example, that light of a wavelength to be detected can be detected separately from lights of other wavelengths. As the detection device, a device known in this technical field or a device commercially available may be used.

On the basis of data concerning the light detected by the detection device, the going direction of the particle is controlled. The control may be conducted, for example, by a controller. For example, the controller determines that a particle is to go into the fourth channel 314 in the case where the light detected in the detection region satisfies a predetermined criterion, and determines that a particle is to go into the third channel 313 in the case where the light does not satisfy the predetermined criterion.

According to another embodiment of the present technology, the particle in the particle-containing liquid is imaged in the isolation determining region 322. On the basis of an image obtained by the imaging, it is determined whether or not the going direction of the particle is to be changed. The determination is performed on the basis of whether or not information acquired from the image satisfies a predetermined criterion. The imaging and the determination may be conducted similarly to imaging and isolation determination conducted, for example, in an image-based flow cytometer.

For the determination based on the image, an imaging device and an image processing device (both not illustrated) may be used. The imaging device images a particle, to acquire a particle image. The imaging device may include, for example, a CMOS or a CCD. The image processing device acquires predetermined data from the particle image. The predetermined data may be, for example, color data, light intensity data, particle shape data, or particle size data, but these are non-limitative.

On the basis of the data acquired by the image processing device, the going direction of the particle may be controlled. The control may be conducted, for example, by a controller. For example, the controller determines that a particle is to go into the fourth channel 314 in the case where the acquired data satisfies a predetermined criterion, and determines that a particle is to go into the third channel 313 in the case where the data does not satisfy the predetermined criterion.

(Transport Step)

The transport step in the particle operating method of the present technology is used for controlling the going of the particle into either the third channel 313 or the fourth channel 314 on the basis of the results of judgement. The control of the going direction of the particle in the transport step will be described below.

As illustrated in FIG. 6, the third channel 313 is a channel in which the particle-containing liquid flows.

As depicted in FIG. 6, the fourth channel 314 is a channel in which a liquid obtained by adding a particle (hereinafter also referred to as the “target particle”) satisfying the predetermined criterion to the non-particle-containing liquid introduced via the second inlet flows (hereinafter the liquid is also referred to as the “target particle-containing liquid”).

At a side surface of the channel in the isolating region 323 (particularly, a side surface with which the particle-containing liquid is in contact), a vibrating section 324 including a material (e.g., a substrate) that absorbs laser light is provided. At the time when the target particle passes through the isolating region 323, the vibrating section 324 is irradiated with laser light L in a pulsed form. By this, vibration is generated in the vibrating section 324. The vibration is propagated to the liquid in the channel, and moves the target particle from a laminar layer of the particle-containing liquid into a laminar layer of the non-particle-containing liquid. In this way, the target particle-containing liquid is formed.

The laser light is preferably laser light of near infrared light, and the material is a material that absorbs near infrared light. These may be the same as those described in (1) and (2) above. Irradiation with the laser light may be conducted, for example, by a process in which the controller drives a laser light irradiation section on the basis of the results of the determination.

(Recovery Step)

The target particle-containing liquid formed in the above-mentioned manner flows into the fourth channel 314, and is recovered through the second outlet 304 present at the terminal end of the fourth channel 314. On the other hand, the particle-containing liquid containing the particle other than the target particle flows into the third channel 313, and is recovered via the third outlet 303 present at the terminal end of the third channel 313.

In this way, only the target particle is isolated from among the particles in the particle-containing liquid introduced via the first inlet 301.

Note that while the target particle is moved by the particle operating method of the present technology in the above description, particles other than the target particle may be moved by the particle operating method according to the present technology. For example, for removing the particles other than the target particle from the particle-containing liquid, the particles other than the target particle may be made to go into the fourth channel 314 and the target particle may be made to go into the third channel 313, by the particle operating method of the present technology.

(3-2) Modification

According to one embodiment of the present technology, the vibrating section may produce vibration that has directivity. For producing vibration having directivity in the example of (3-1) above, for example, the vibrating section may be provided in a hollow provided in a side surface of a channel. This embodiment will be described below referring to FIGS. 7 to 9.

As illustrated in FIG. 7, a vibrating section 331 provided in the inside of a hollow 330 provided in a channel side wall may be used, in place of the vibrating section 324 provided at a channel side surface in FIG. 6. By this, the vibration can be provided with directivity.

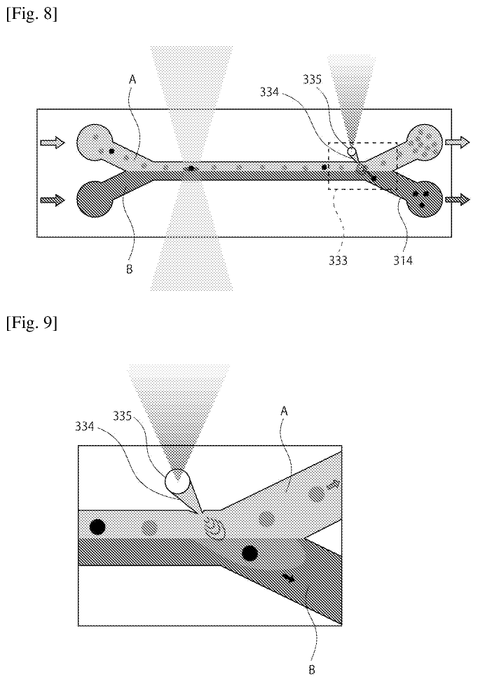

FIG. 8 is the same as FIG. 6 except that the isolating region 323 is changed to an isolating section 333. FIG. 9 is an enlarged view of the isolating section 333.

As illustrated in FIGS. 8 and 9, a wall surface of a channel of the isolating section 333 (particularly, a wall surface with which the particle-containing liquid makes contact) is provided with a hollow 334. The hollow 334 opens toward the fourth channel 314. The size of an opening of the hollow is preferably smaller than the size of the particles. As a result, the particles can be prevented from entering the hollow. The size of the opening of the hollow (for example, the diameter in the case of a circular shape, and the short side in the case of a rectangular shape) may be, for example, equal to or less than 30 μm, preferably equal to or less than 20 μm, and more preferably equal to or less than 10 μm. The size may be, for example, equal to or more than 1 μm, particularly equal to or more than 2 μm, and more particularly equal to or more than 5 μm.

A vibrating section 335 is provided in the inside of the hollow 334. The vibrating section 335 is a near infrared light-absorbing metallic chip or thin film. The maximum size (for example, diameter) of the vibrating section 335 may be, for example, 20 to 200 μm, preferably 50 to 150 μm.

The vibration generated in the case where the vibrating section 335 is irradiated with pulsed laser of near infrared light has directivity. That is, the a vibration stimulus caused by the vibrating section 335 is provided at an angle relative to the third channel to direct a particle from the third channel to the fourth channel 314. For example, the vibration goes in the opening direction (the fourth channel 314) of the hollow, and is not liable to spread.

The shape of the hollow 334 may preferably be a nozzle-like shape as depicted in FIGS. 8 and 9. The “nozzle-like shape” herein means that the sectional area of the hollow gradually decreases in going from the depth (the part where the vibrating section is provided) of the hollow toward the opening of the hollow. With the hollow being nozzle-like in shape, vibration having directivity is easily generated.

As illustrated in FIG. 9, at the time when the target particle passes through the isolating region, the vibrating section 335 is irradiated with pulsed laser of near infrared light. The vibration stimulus generated by the irradiation is transmitted through the particle-containing liquid at an angle, and moves the target particle from a laminar flow A into a laminar flow B.

Since the vibration has directivity as described above, the influence on the going directions of the particles present before and after the target particle can be reduced. In addition, by the directivity, the intervals between the target particle and the particles present before and after the target particle can be narrowed more. Since the particles can be disposed at narrower intervals, more efficient isolation of the particle can be realized.

The position of irradiation with the pulsed laser may preferably be changed gradually. By this, abrasion of the vibrating section by ablation due to repeated irradiation of the same position with the pulsed laser can be prevented.

(3-3) Modification

While the two laminar flows flow in the isolation determining channel in (3-1) and (3-2) above, the number of laminar flows flowing in the isolation determining channel is not limited to two, and may be, for example, equal to or more than 2, particularly 2 to 5, and more particularly 2, 3, 4, or 5. In the case where plural laminar flows are made to flow in the isolation determining channel as described above, the number of the inlets and the number of the channels in which the fluids introduced via the inlets flow may be increased accordingly. By the particle operating method of the present disclosure, the particle contained in any one of the plural laminar flows may be moved into another laminar flow.

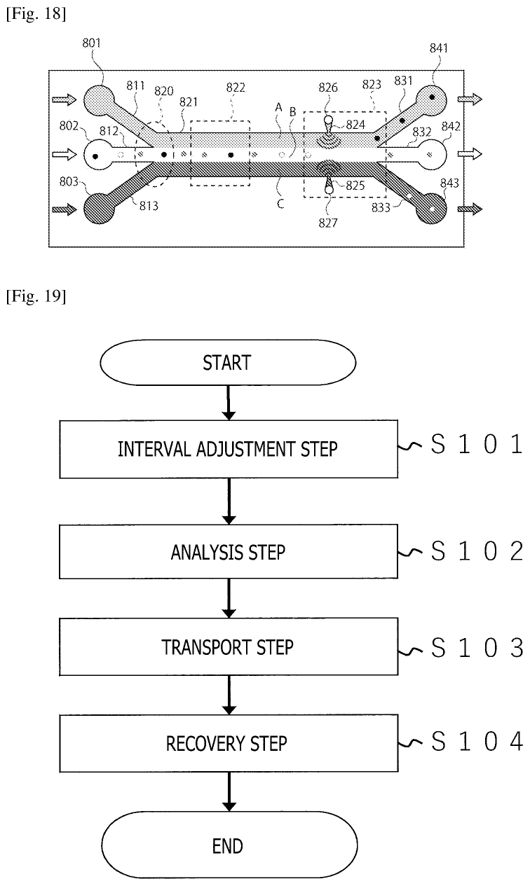

An application example of the present technology in the case where three laminar flows flow in a channel will be described below referring to FIGS. 17 and 18.

(3-3-1) Configuration example of microchannel chip used in particle operating method of present technology

FIG. 17 depicts an example of a microchannel chip for isolating specified two kinds of particles from a plurality of kinds of particles.

A microchannel chip 700 illustrated in FIG. 17 includes a first inlet 701 through which a particle-containing liquid is introduced, a first channel 711 in which the liquid introduced via the first inlet 701 flows, a second inlet 702 through which a non-particle-containing liquid is introduced, a second channel 712 in which the liquid introduced via the second inlet 702 flows, a third inlet 703 through which a non-particle-containing liquid is introduced, and a third channel 713 in which the liquid introduced via the third inlet 703 flows.

The microchannel chip 700 has a confluence section 720 where the first channel 711, the second channel 712, and the third channel 713 join one another.

The microchannel chip 700 further includes an isolation determining channel 721 in which the fluids having joined one another at the confluence section 720 flow.

The isolation determining channel 721 is provided with an isolation determining region 722 and an isolating region 723. In the isolation determining region 722, it is determined whether or not a particle is to be isolated. In the isolating region 723, isolation based on the results of the determination is conducted.

A side surface of a channel in the isolating region 723 (particularly, a side surface with which a laminar flow A of the particle-containing liquid is in contact) is provided with a vibrating section 724 including a material that absorbs laser light. Alternatively, the vibrating section 724 may be a vibrating section provided inside a hollow provided in a channel wall surface, as described above referring to FIG. 7.

In the isolating region 723, the isolation determining channel 721 is branched into a first discharge channel 731, a second discharge channel 732, and a third discharge channel 733. A first outlet 741, a second outlet 742, and a third outlet 743 are provided respectively at terminal ends of these three discharge channels, and liquids may be discharged via these outlets to the outside of the microchannel chip 700.

Into the isolation determining channel 721, fluid can penetrate only from the first channel 711, the second channel 712, and the third channel 713, and the first discharge channel 731, the second discharge channel 732, and the third discharge channel 733 which are preliminarily connected to the isolation determining channel 721; in other words, the inside of the isolation determining channel 721 is a closed space.

(3-3-2) Example of Particle Operation

(Conduction Step)

A particle-containing liquid is introduced through the first inlet 701. The particle-containing liquid flows in the first channel 711 in a laminar flow state toward the confluence section 720. The plural particles contained in the particle-containing liquid are flowing with intervals therebetween in the first channel 711. The particle-containing liquid contains a first kind of particles (grey particles in FIG. 17) and a second kind of particles (white particles in the figure) which are to be isolated, and unrequired particles (black particles in the figure).

Two non-particle-containing liquids are introduced through the second inlet 702 and the third inlet 703. The two non-particle-containing liquids flow in the second channel 712 and the third channel 713 in a laminar flow state toward the confluence section 720.

At the confluence section 720, the particle-containing liquid and the two nonparticle-containing liquids join one another. These three liquids are not mixed with one another, and flow as three layers of liquids (laminar flows A, B, and C) in the isolation determining channel 721 toward the isolating region 723. In the isolation determining channel 721 as well, the plural particles contained in the particle-containing liquid are flowing with intervals therebetween.

(Analysis Step)

Isolation determination in the isolation determining region 722 may be conducted as described in the (Analysis Step) in “(3-1-2) Example of particle operation” above.

On the basis of the data acquired in the isolation determining region 722, the going direction of the particles is controlled. The control may be performed, for example, by a controller. For example, the controller may determine that a particle is to go into the second discharge channel 732 in the case where the data satisfies a predetermined first criterion, may determine that a particle is to go into the third discharge channel 733 in the case where the data satisfies a predetermined second criterion, and may determine that a particle is to go into the first discharge channel 731 in the case where the data satisfies neither of the first criterion and the second criterion. Here, the first criterion is a criterion for specifying the grey particles in FIG. 17, and the second criterion is a criterion for specifying the white particles in the figure. These criteria may be, for example, criteria based on fluorescence and/or scattered light, or may be criteria based on image information.

(Transport Step)

The transport step in the particle operating method of the present technology is used for controlling the going of a particle into one of the first discharge channel 731, the second discharge channel 732, and the third discharge channel 733 on the basis of the results of the determination. The control of the going direction of the particle in the transport step will be described below.

In the isolation determining channel 721, the particle-containing liquid having flowed through the first channel 711 is forming a laminar flow A. In the isolation determining channel 721, the non-particle-containing liquid having flowed through the second channel 712 is forming a laminar flow B, and the non-particle-containing liquid having flowed through the third channel 713 is forming a laminar flow C.

A side surface of a channel in the isolating region 723 (particularly, a side surface with which the laminar flow A of the particle-containing liquid is in contact) is provided with a vibrating section 724 including a material that absorbs laser light. At the time when a target particle passes through the isolating region 723, the vibrating section 724 is irradiated with laser light L in a pulsed form. As a result, vibration is generated in the vibrating section 724. The vibration is propagated to the liquid in the channel, and moves the target particle from the laminar flow A of the particle-containing liquid into the laminar flow B or the laminar flow C of the nonparticle-containing liquid. In this way, the moving direction of the particles may be changed.

The particles may be moved from the laminar flow A into either the laminar flow B or the laminar flow C. The destination of moving of the particle (that is, the laminar flow B or C) may be changed, for example, by changing one or more parameters selected from the group including pulse width, repetition frequency, pulse energy, peak intensity, and average intensity of the laser light L. For instance, the peak intensity of the laser light L for generating vibration for moving the particle into the laminar flow C may be greater than the peak intensity of the laser light L for generating vibration for moving the particle into the laminar flow B.

For example, in the case where the data acquired by isolation determination conducted for the particle in the isolation determining region 722 satisfies the first criterion, the controller drives the laser light irradiation section to irradiate the vibrating section 724 with pulsed laser in such a manner that the particle is moved from the laminar flow A into the laminar flow B. The particles (grey) moved into the laminar flow B flow through the second discharge channel 732 toward the second outlet 742.

In the case where the data acquired by isolation determination conducted for the particle in the isolation determining region 722 satisfies the second criterion, the controller drives the laser light irradiation section to irradiate the vibrating section 724 with pulsed laser in such a manner that the particle is moved from the laminar flow A into the laminar flow C. The particles (white) moved into the laminar flow C flow through the third discharge channel 733 toward the third outlet 743.

In the case where the data acquired by isolation determination conducted for the particle in the isolation determining region 722 satisfies neither of the first criterion and the second criterion, the controller does not drive the laser light irradiation section. As a result, the particles (black) flow in the laminar flow A without any change, and flow through the first discharge channel 731 toward the first outlet 741.

The laser light L is preferably laser light of near infrared light, and the material is a material that absorbs near infrared light. These may be the same as those described in (1) and (2) above. Irradiation with the laser light may be conducted, for example, by a process in which the controller drives the laser light irradiation section on the basis of the results of the determination.

(Recovery Step)

The particles moved into the laminar flow B (that is, the particles determined to satisfy the first criterion) flow through the second discharge channel 732 toward the second outlet 742, and are recovered through the second outlet 742.

The particles moved into the laminar flow C (that is, the particles determined to satisfy the second criterion) flow through the third discharge channel 733 toward the third outlet 743, and are recovered through the third outlet 743.

The particles flowing in the laminar flow A without any change in the moving direction (that is, the particles determined to satisfy neither of the first criterion and the second criterion) flow through the first discharge channel 731 toward the first outlet 741, and are recovered through the first outlet 741.

In this way, the particles satisfying the first criterion and the particles satisfying the second criterion are isolated.

(3-3-3) Another Configuration Example of Microchannel Chip Used in Particle Operating Method of Present Technology

FIG. 18 depicts an example of a microchannel chip for isolating the particle having a specified characteristic from plural particles. A microchannel chip 800 illustrated in FIG. 18 includes a first inlet 801 through which a non-particle-containing liquid is introduced, a first channel 811 in which the liquid introduced via the first inlet 801 flows, a second inlet 802 through which a particle-containing liquid is introduced, a second channel 812 in which the liquid introduced via the second inlet 802 flows, a third inlet 803 through which a non-particle-containing liquid is introduced, and a third channel 813 in which the liquid introduced via the third inlet 803 flows.

The microchannel chip 800 has a confluence section 820 where the first channel 811, the second channel 812, and the third channel 813 join one another.

The microchannel chip 800 further has an isolation determining channel 821 in which the fluids having joined one another at the confluence section 820 flow.

The isolation determining channel 821 is provided with an isolation determining region 822 and an isolating region 823. In the isolation determining region 822, it is determined whether or not the particle is to be isolated. In the isolating region 823, isolation based on the results of the determination is conducted.

A wall surface of a channel of the isolating region 823 is provided with two hollows 824 and 825. The hollow 824 is provided in the wall surface with which the laminar flow A is in contact, while the hollow 825 is provided in the wall surface with which the laminar flow C is in contact. Vibrating sections 826 and 827 including a laser light absorbing material are provided in the hollows 824 and 825.

In the isolating region 823, the isolation determining channel 821 is branched into a first discharge channel 831, a second discharge channel 832, and a third discharge channel 833. A first outlet 841, a second outlet 842, and a third outlet 843 are provided at respective terminal ends of these three discharge channels, and liquids may be discharged through these outlets to the outside of the microchannel chip 800.

Into the isolation determining channel 821, liquids can penetrate only through the first channel 811, the second channel 812, and the third channel 813, and the first discharge channel 831, the second discharge channel 832, and the third discharge channel 833 which are preliminarily connected to the isolation determining channel 821; in other words, the inside of the isolation determining channel 821 is a closed space.

(3-3-4) Example of Particle Operation

(Conduction Step)

A non-particle-containing liquid is introduced through the first inlet 801. The nonparticle-containing liquid flows in a laminar flow state in the first channel 811 toward the confluence section 820.

A particle-containing liquid is introduced through the second inlet 802. The particle-containing liquid flows in a laminar flow state in the second channel 812 toward the confluence section 820. Plural particles contained in the particle-containing liquid flow with intervals therebetween in the second channel 812. The particle-containing liquid contains a first kind of particles (black particles in FIG. 18) and a second kind particles (white particles in the figure) which are to be isolated, and unrequired particles (grey particles in the figure).

A non-particle-containing liquid is introduced through the third inlet 803. The nonparticle-containing liquid flows in a laminar flow state in the third channel 813 toward the confluence section 820.

At the confluence section 820, the particle-containing liquid and the two nonparticle-containing liquids join one another. These three liquids are not mixed with one another, and flow as three layers of liquids (laminar flows A, B, and C) in the isolation determining channel 821 toward the isolating region 823. In the isolation determining channel 821 as well, the plural particles contained in the particle-containing liquid are flowing with intervals therebetween.

(Analysis Step)

Isolation determination in the isolation determining region 822 may be conducted as described in the (Analysis Step) of “(3-1-2) Example of particle operation” above.

On the basis of the data acquired in the isolation determining region 822, the going direction of the particles is controlled. The control is conducted, for example, by a controller. For instance, the controller may determine that the particle is to go into the first discharge channel 831 in the case where the data satisfies the predetermined first criterion, may determine that the particle is to go into the third discharge channel 833 in the case where the data satisfies the predetermined second criterion, and may determine that the particle is to go into the first discharge channel 832 in the case where the data satisfies neither of the first criterion and the second criterion.

(Transport Step)

A transport step in the particle operating method of the present technology is used for controlling the going of the particle into one of the first discharge channel 831, the second discharge channel 832, or the third discharge channel 833 on the basis of the results of the determination. The control of the going direction of the particles in the transport step will be described below.

In the isolation determining channel 821, the particle-containing liquid having flowed through the second channel 812 is forming a laminar flow B. In the isolation determining channel 821, the non-particle-containing liquid having flowed through the first channel 811 is forming a laminar flow A, and the non-particle-containing liquid having flowed through the third channel 813 is forming a laminar flow C.

A side surface of a channel in the isolating region 823 (particularly, a side surface with which the laminar flow A of the non-particle-containing liquid is in contact) is provided with a hollow 824 in which a vibrating section 826 including a laser light absorbing material is accommodated.

A side surface on the opposite side of the channel in the isolating region 823 (particularly, a side surface with which the laminar flow C of the non-particle-containing liquid is in contact) is provided with a hollow 825 in which a vibrating section 827 including a laser light absorbing material is accommodated.

At the time when the target particle passes through the isolating region 823, either of the vibrating sections 826 and 827 is irradiated with laser light in a pulsed form. As a result, either of the vibrating sections 826 and 827 produces vibration. The vibration is propagated to the liquid in the channel, and moves the target particle from the laminar flow B of the particle-containing liquid into the laminar flow A or the laminar flow C of the non-particle-containing liquid. In this way, the moving direction of the particle may be changed.

The particle may be moved from the laminar flow B into either the laminar flow A or the laminar flow C. The destination of moving of the particle (that is, the laminar flow A or C) may be changed, for example, by changing one or more parameters selected from the group including pulse width, repetition frequency, pulse energy, peak intensity, and average intensity of the laser light L.

For instance, in the case where the data acquired by isolation determination conducted for a particle in the isolation determining region 822 satisfies the first criterion, the controller drives the laser light irradiation section to irradiate the vibrating section 827 with pulsed laser in such a manner that the particle is moved from the laminar flow B into the laminar flow A. The particle having been moved into the laminar flow A flows through the first discharge channel 831 toward the first outlet 841.

In the case where the data acquired by isolation determination conducted for a particle in the isolation determining region 822 satisfies the second criterion, the controller drives the laser light irradiation section to irradiate the vibrating section 826 with pulsed laser in such a manner that the particle is moved from the laminar flow B into the laminar flow C. The particle having been moved into the laminar flow C flows through the third discharge channel 833 toward the third outlet 843.

In the case where the data acquired by isolation determination conducted for a particle in the isolation determining region 822 satisfies neither of the first criterion and the second criterion, the controller does not drive the laser light irradiation section. As a result, the particle flows in the laminar flow B without any change, and flows through the second discharge channel 832 toward the first outlet 842.

The laser light L is preferably laser light of near infrared light, and the material is preferably a material that absorbs near infrared light. These may be the same as those described in (1) and (2) above. Irradiation with the laser light may be conducted, for example, by a process in which the controller drives the laser irradiation section on the basis of the results of the determination.

(Recovery Step)

The particles having been moved into the laminar flow A (that is, the particles determined to satisfy the first criterion) flow through the first discharge channel 831 toward the first outlet 841, and are recovered through the first outlet 841.

The particles having been moved into the laminar flow C (that is, the particles determined to satisfy the second criterion) flow through the third discharge channel 833 toward the third outlet 843, and are recovered through the third outlet 843.

The particles flowing in the laminar flow B without any change in moving direction (that is, the particles determined to satisfy neither of the first criterion and the second criterion) flow through the second discharge channel 832 toward the second outlet 842, and are recovered through the second outlet 842.

In this manner, the particles satisfying the first criterion and the particles satisfying the second criterion are isolated.

### 2. SECOND EMBODIMENT (PARTICLE TRAPPING CHIP)

### (1) Description of Second Embodiment

The present technology also provides a particle trapping chip including a substrate, at least one well provided on the substrate, and a vibrating section which is included in the substrate and includes a material that absorbs laser light. The vibrating section, by being irradiated with the laser light in a pulsed form, may produce vibration. By the particle trapping chip, the particle operation method of the present technology can be carried out.

The particle trapping chip of the present technology is used for trapping a particle into the at least one well. Further, the particle trapping chip of the present technology has the vibrating section. With the vibrating section irradiated with the laser light in a pulsed form, the particle trapped in the well can be moved from the inside of the well to the outside of the well.

In regard of the laser light, the vibrating section, and the particle, all the contents described in (1) of 1 above also apply to this embodiment. Therefore, descriptions of the laser light, the vibrating section, and the particle will be omitted. The particle trapping chip of the present technology may be, for example, the particle trapping chip 100 with the vibrating section introduced thereto described in (2) of 1 above. In addition, the particle trapping chip of the present technology may be used, for example, in the particle operating method and an application example thereof described in (1) of 1 above.

### (2) First Example of Second Embodiment (Chip Including Laser Light Absorbing Material)

According to one embodiment of the present technology, the substrate as a whole may include a material that absorbs laser light, or that part of the substrate which is in a region where the well is formed may include a material that absorbs laser light. In other words, the substrate itself may function as the vibrating section.

An example of this embodiment is the particle trapping chip 100 described in (2-2) of 1 above, and all the descriptions in the above also apply to this embodiment.

### (3) Second Example of Second Embodiment (Vibrating Section Provided at Well Surface or Surface on the Opposite Side)

According to another embodiment of the present technology, the vibrating section may be formed on at least part of a surface of the substrate. For example, the vibrating section may be formed on a surface formed with the well or a surface on the opposite side of the surface (a surface not formed with the well), of the two surfaces of the substrate. In the present embodiment, the vibrating section may be, for example, a layer (thin film) including a material that absorbs laser light.

In the case where the vibrating section is provided on the surface formed with the well, the vibrating section may be provided, for example, on at least part of an inner wall of the well, and may be provided, specifically, on a bottom surface or a side surface of the well.

In the case where the vibrating section is provided on the surface not formed with the well, the vibrating section may be formed, for example, on the whole surface of the surface, or may be provided on only that part of the surface which corresponds to the well.

An example of this embodiment is the particle trapping chip in Modifications 1 and 2 described in (2-3) and (2-4) of 1 above, and all the descriptions in the above also apply to this embodiment.

### 3. THIRD EMBODIMENT (PARTICLE OPERATING SYSTEM)

### (1) Description of Third Embodiment

A particle operating system of the present technology includes: a particle trapping chip including a substrate, at least one well provided on the substrate, and a vibrating section which is included in the substrate and includes a material that absorbs laser light; and a laser light irradiation section that irradiates the well with the laser light in a pulsed form. By the combination of the particle trapping chip and the laser light irradiation section, the particle operating method of the present technology can be carried out.

The particle trapping chip is as described in 2 above, and the description in the above also applies to this embodiment.

The laser light irradiation section irradiates the well with the laser light in a pulsed form. The laser light is as described in 1 above, and the description in the above also applies to this embodiment.

The laser light irradiation section may preferably include a laser light source, and a condenser lens that converges pulsed laser light emitted from the laser light source. The laser light source is as described in (1) of 1 above. The lens may be, for example, an objective lens.

The numerical aperture NA of the condenser lens may be, for example, 0.05 to 0.5, preferably 0.1 to 0.3. A condenser lens having such a numerical aperture is suitable for operating particles, according to the present technology.

The laser light irradiation section may include other optical parts.

For instance, the laser light irradiation section may include a beam expander. By the beam expander, the beam diameter of laser light emitted from the laser light source may be adjusted to a beam diameter suitable for being incident on the condenser lens (for example, objective lens). By the beam expander, the beam diameter (diameter or long diameter) of the laser light emitted from the laser light source may be formed into, for example, 2 to 20 mm, preferably 5 to 15 mm, and more preferably 8 to 12 mm.

The laser light irradiation section may further include a combination of a half-wave plate and a polarizing beam splitter (PBS). For example, laser light adjusted in beam diameter by the beam expander may be transmitted through the half-wave plate, and the transmitted laser light may be reflected on or transmitted through the PBS, to be incident on the condenser lens. By the combination, the amount of pulsed laser light incident on the condenser lens can easily be adjusted.

### (2) Example of Third Embodiment (Particle Operating System)

(2-1) Configuration Example of Particle Operating System

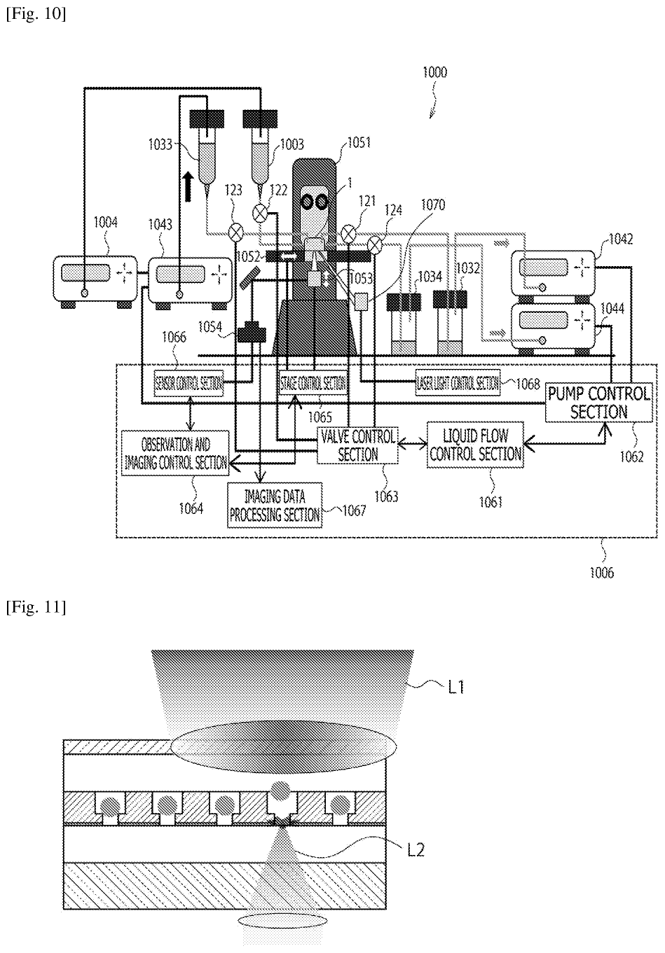

A more specific example of the particle operating system of the present technology will be described below referring to FIG. 10. FIG. 10 is a schematic diagram depicting an example of the particle operating system of the present technology.

A particle operating system 1000 of the present technology illustrated in FIG. 10 includes the particle trapping chamber 1 described in “(2-2) Application Example of the Present Technology” of 1 above. As has been described in “(2-2) Application Example of Present Technology” of 1 above, the substrate 101 of the particle trapping chamber 1 includes a material containing constituents that absorb laser light, and, in other words, can produce vibration for moving a particle inside a well to the outside of the well, by irradiation with pulsed laser.

A liquid supply tank 1003 as a fluid supply section is connected through a valve 122 to the first fluid supply channel section 112, of the constituent elements of the particle trapping chamber 1. A minute-pressure pump 1004 is connected to the liquid supply tank 1003. By driving the minute-pressure pump 1004, fluid can be supplied into the particle trapping chamber 1.

A liquid supply tank 1033 is connected through a valve 123 to the second fluid supply channel section 113. A minute-pressure pump 1043 is connected to the liquid supply tank 1033. By driving the minute-pressure pump 1043, fluid can be supplied into the particle trapping chamber 1.

A waste liquid tank 1032 and a minute-pressure pump 1042 are connected through a valve 121 to the suction channel section 111. By driving the minute-pressure pump 1042, suction through the suction channel section 111 can be performed.

A particle recovery vessel 1034 and a minute-pressure pump 1044 are connected through a valve 124 to the fluid discharge channel section 114. By driving the minute-pressure pump 1044, suction through the fluid discharge channel section 114 can be conducted. The fluid discharge channel section 114 is used, for example, for recovering a particle moved from the inside of a well to the outside of the well by irradiation with laser light by a laser light irradiation section 1070.

These valves may preferably be electrically driven pinch valves. In addition, these minute-pressure pumps can preferably adjust pressure in a pressure range of preferably 10 to 3,000 Pa, more preferably 100 to 2,000 Pa, and for example, 100 to 1,000 Pa, by increments of preferably 10 to 300 Pa, more preferably 20 to 200 Pa.

A control section 1006 (particularly, a liquid flow control section 1061) may control the opening/closing of these valves and/or the driving of the minute-pressure pumps, whereby, for example, the supply and/or suction of the liquid in each of the steps in “(2-2-2) Example of particle operation” of 1 above may be performed.

The particle trapping chamber 1 is disposed on a stage 1052 of an inverted microscope 1051. The stage 1052 can be moved by electric control, and can be moved, for example, in an X direction and a Y direction.

An objective lens 1053 of the inverted microscope 1051 can be moved by electric control, and can be moved, for example, in a Z direction. The objective lens 1053 is configured such that a particle trapping surface of the particle trapping chamber 1 can be observed from below the particle trapping chamber 1.

The inverted microscope 1051 may be provided with, for example, a light source (for example, a halogen lamp, a mercury lamp, an LED, or the like), a filter (for example, an excitation filter and/or a fluorescence filter, etc.), an objective lens having a magnification according to the purpose, an electrically driven XY stage, and an electrically driven Z stage (may be a stage for moving the objective lens or a stage on which to place the chamber).

A camera 154 is connected to the inverted microscope 1051. The camera 1054 is configured such that the particle trapping surface of the particle trapping chamber 1 can be imaged through the objective lens 1053. The camera 1054 includes, for example, a CMOS or CCD image sensor. The camera 1054 is configured to be able to transmit imaging data to an imaging data processing section which will be described below.

The particle operating system 1000 includes the laser light irradiation section 1070. The laser light irradiation section 1070 irradiates the vibrating section in the particle trapping chamber 1 with pulsed laser. Control of the irradiation position of the pulsed laser will separately be described in (2-2) and (2-3) below.

The particle operating system 1000 includes a control section 1006. The control section 1006 includes a liquid flow control section 1061, a pump control section 1062, a valve control section 1063, an observation and imaging control section 1064, a stage control section 1065, a sensor control section 1066, an imaging data processing section 1067, and a laser light control section 1068.

The liquid flow control section 1061 controls the pump control section 1062 and the valve control section 1063, to control the supply of fluid into the particle trapping chamber 1 or the discharge of the fluid from the particle trapping chamber 1. The liquid flow control section 1061 controls, for example, capture of cells, chemical exchange, and/or recovery of cells.

The pump control section 1062 controls operations of the minute-pressure pumps and/or differential pressures given by the minute-pressure pumps.

The valve control section 1063 controls the opening/closing of the valves.

The liquid flow control section 1061 may control the opening/closing of the valves and/or the driving of the minute-pressure pumps, whereby the supply and/or suction of the liquid in each of the steps in “(2-2-2) Example of particle operation” of 1 above may be performed.

For example, in the particle trapping step, the liquid flow control section 1061 opens the valve 122 and the valve 123, and drives the minute-pressure pump 1004 to supply the particle-containing liquid through the first fluid supply channel section 112 into the particle trapping chamber 1, and drives the minute-pressure pump 1042 to perform suction through the suction channel section 111, whereby the particles are trapped in the wells 105. In the particle trapping step, other valves may be in a closed state.

In the analysis step, the liquid flow control section 1061 may close all the valves. Alternatively, the liquid flow control section 1061 opens the valve 121, and drives the minute-pressure pump 1042, whereby suction through the suction channel section 111 may be performed. During the suction, other valves may be in a closed state. By these operations, a state in which the particles are trapped in the wells is maintained. In the transport step, first, the liquid supply tank 1003 is replaced with a tank that contains the non-particle-containing liquid (for example, buffer solution). Next, the liquid flow control section 1061 opens the valve 122 and the valve 124. Then, the liquid flow control section 1061 drives the minute-pressure pump 1044, to supply the non-particle-containing liquid through the first fluid supply channel section 112, and drives the minute-pressure pump 1004, to perform suction through the fluid discharge channel section 114. As a result, a flow in which the particles having been moved from the inside of the well to the outside of the well go toward the fluid discharge channel section 114 is formed.

In the recovery step, the particles going with the flow go through the fluid discharge channel section 114, to be recovered into the particle recovery vessel 1034.

The observation and imaging control section 1064 controls the stage control section 1065 and the sensor control section 1066, to perform imaging of the particle trapping surface.

The stage control section 1065 controls the stage 1052 and/or the objective lens 1053. By the stage control section 1065, the region to be imaged may be moved and/or the focus may be adjusted. In addition, the stage control section 1065 may move the stage 1052 in such a manner that the cell selected in the analysis step is irradiated with the pulsed laser from the laser light irradiation section 1070.

The sensor control section 1066 controls the camera 1054. By the sensor control section 1066, for example, the timing of imaging of the particle trapping surface, exposure period, and/or number of times of imaging may be controlled.

By the observation and imaging control section 1064, the control of the stage by the stage control section 1065 and the control of camera operation by the sensor control section 1066 may be synchronized. In addition, the observation and imaging control section 1064 may control the rotation of an electric revolver to which plural objective lenses 1053 are attached. In other words, the observation and imaging control section 1064 may switch the objective lenses 1053.

The imaging data processing section 1067 processes imaging data transmitted from the camera 1054. For example, the imaging data processing section 1067 may acquire imaging data of the particle trapping region as a whole, by synthesizing a plurality of imaging data obtained by imaging different regions of the particle trapping region.

The laser light control section 1068 controls the laser light irradiation section 1070. By the control, the laser light irradiation section 1070 irradiates the selected well in the particle trapping chamber 1 with pulsed laser. The laser light control section 1068 may control, for example, irradiation conditions and/or irradiation timing of the pulsed laser.

The control section 1006 may include, for example, a hard disk in which a program for causing the particle operating system 1000 to perform the particle operating method according to the present technology and an OS are stored, a CPU, and a memory. For example, the above-mentioned functions (particularly, the functions of the above-mentioned control sections) of the control section 1006 may be realized in a general-purpose computer. The program may, for example, be recorded in a recording medium such as a micro SD memory card, an SD memory card, or a flash memory. The program recorded in the recording medium may be read out by a drive provided in the particle operating system 1000, and then, according to the program thus read out, the control section 1006 may drive each of the components of the particle operating system 1000, whereby the particle operating method according to the present technology may be carried out.

(2-2) First Example of Control of Pulsed Laser Irradiation Position (XY Stage Movement)

According to one embodiment of the present technology, the particle trapping chip may be movable relative to the position of the laser light irradiation section. For example, the position of the laser light irradiation section may be fixed, whereas the particle trapping chip may be movable. This embodiment will be described referring to FIG. 10. In this embodiment, the position of the laser light irradiation section 1070 illustrated in FIG. 10 is fixed. On the other hand, the particle trapping chamber 1 including the particle trapping chip is disposed on the stage 1052. The stage 1052 may be moved, for example, by electric control, and the movement may be controlled by the stage control section 1065. The stage 1052 may be moved, for example, in X and Y directions, or may be moved in a Z direction. Therefore, by moving the position of the stage 1052 in these directions, the irradiation position of the laser light by the laser light irradiation section 1070 may be moved.

For example, the particle trapping chip is disposed on an electrically driven XY sage, and, by the movement of the XY stage, the well in which the selected cell is trapped may be moved to a laser light irradiation position of the laser light irradiation section which is fixed. A series of processes of the movement of the XY stage, stopping of the movement, and irradiation with laser may be repeated. Where the period of time of the processes per cell is 0.3 second, if the cells to be recovered is 10,000, the recovery can be finished within one hour. The cell operation in this example is faster than the cell operation by a manipulator in related art.

In the case where higher speed is required, for example, while the stage is moved at a fixed speed, the wells in which selected cells are trapped may be irradiated with the pulsed laser in a timed manner. For example, where irradiation with 10 pulses at a frequency of 5 kHz is conducted while the stage is moved at a stage moving speed of 5 mm/s, the moving distance in that period of time is at most 10 μm, and the moving distance can be made smaller than the well inside diameter. Therefore, even by this technique, only the target cells can be taken out. For example, in the case where the well pitch is 50 μm, irradiation with the pulsed laser can be performed at a speed of, for example, 100 wells/sec, and, therefore, the moving treatment for 100,000 wells can be performed in 1,000 seconds.

In this example, before the particle operating method of the present technology is conducted or before the transport step is performed, a calibration step may be carried out. In the calibration step, for example, specification of the position of each well may be conducted. The specification of the position may be carried out, for example, by utilizing at least one well provided with the mark described in (2-2-1) of 1 above. For instance, after the particle trapping chip is set in the particle operating apparatus, the coordinates of at least one well (particularly, plural wells) provided with the mark may be detected, and, on the basis of the coordinates, specification of the position of each well is conducted. By the calibration step, the transport step can be performed more efficiently.

(2-3) Second Example of Control of Pulsed Laser Irradiation Position (Scanning of Laser Light Irradiation Position)

According to another embodiment of the present technology, the laser light irradiation section may include an optical system by which the irradiation position of the laser light can be changed. For example, the position of the particle trapping chip may be fixed, whereas the reaching position of the pulsed laser emitted from the laser light irradiation section may be changed. This embodiment will be described referring to FIG. 10. In this embodiment, the laser light irradiation section 1070 depicted in FIG. 10 may include an optical system by which the irradiation position of the laser light can be changed. The optical system preferably includes a scanning mirror. The scanning mirror may be, for example, a Galvano scanner or a MEMS mirror. By the scanning mirror, the laser light irradiation position can be changed at high speed.

In this example, for example, several tens of thousands or more cells can all be recovered at high speed. For example, even by taking into consideration that the laser light irradiation position stands still on the well at the time of irradiation with the pulsed laser, a cell moving treatment at a speed of equal to or more than 1,000 wells/sec is possible. For example, 10,000 to 200,000, particularly 20,000 to 150,000 particles (particularly, cells) can be recovered being classified into a plurality of cell groups. In the present technology, for example, the accuracy of the laser light irradiation position allows an error on the order of ±5 μm. Therefore, a high-speed operation can be performed for recovering the cells at high speed. The cell operation in this example is also quite faster as compared with cell operation by a manipulator in related art.

A combination of the stage movement in the first example and the scanning mirror in this example may be adopted in the present technology. As a result, for example, even in the case where the area of the particle trapping region is larger than the range in which the laser light irradiation can be performed through the scanning mirror, a particle moving treatment can be performed for the whole surface of the particle trapping region.

In this example as well, the calibration step described in (2-2) above may be carried out, and, by the step, the transport step can be performed more efficiently.

### 4. FOURTH EMBODIMENT (PARTICLE TRAPPING CHAMBER)

### (1) Description of Fourth Embodiment

The present technology also provides a particle trapping chamber including a substrate, at least one well provided on the substrate, a vibrating section which is included in the substrate and includes a material that absorbs light, and a channel used for recovering particles moved from the inside of the well to the outside of the well. Since the particle trapping chamber of the present technology includes the vibrating section, the particle trapped in the at least one well can be moved from the inside of the well to the outside of the well selectively and at high speed, by the particle operating method according to the present technology. In addition, since the particle trapping chamber includes the channel for recovering the particles moved to the outside of the well, it is possible, for example, to recover the target particles.

In regard of the laser light, the vibrating section, and the particles, all the contents described in (1) of 1 above also apply to this embodiment. Therefore, descriptions of the laser light, the vibrating section, and the particles will be omitted. The channel used for recovery of the particles may be, for example, the particle recovery channel described in (1) of 1 above, or may be the fluid discharge channel section described in (2) of 1 above.

Examples of the particle trapping chamber of the present technology include the particle trapping chambers described in (2-2) to (2-4) of 1 above, but these are not limitative.

In addition, the particle trapping chamber of the present technology may be used, for example, in the particle operating methods described in (1) and (2) of 1 above.

### 5. EXAMPLES

### (1) Operation of Particle Trapped in Well

(1-1) Movement of Particle Trapped in Well (Perpendicular incidence of laser light)

A particle trapping chamber which has a configuration similar to that of the particle trapping chamber 1 described referring to FIG. 1 in (2-1) of 1 above was prepared. Of the particle trapping chamber, the material of a substrate was a silicon resin (PDMS; MS-1001, Dow Corning Toray Co., Ltd.). The particle trapping region was circular in shape with a diameter of 6 mm. In the particle trapping region, 7,800 wells were provided in a grid pattern. The pitches of the wells were 60 μm in both an X direction and a Y direction. Each well had a square opening with each side being 20 μm and a depth of 20 μm. At a bottom portion of each well, a hole communicating with the surface on the other side was provided, and the hole was rectangular slit-like in shape, and had an opening of 5 μm by 10 μm, and a depth of 10 μm.

On a surface on the opposite side of the particle trapping chamber, a layer of gold-palladium alloy was formed by sputtering. The gold-palladium alloy is excellent in near infrared light absorbing property. The layer is a vibrating section to be irradiated with the laser light described below.

A laser light source that emits laser light of near infrared light in a pulsed form was prepared. The laser light source was an Nd:YAG laser that oscillates laser light by a Q switch system. Parameters of the laser light emitted from the laser light source were as follows.

<Laser Light Parameters>

Wavelength λ: 1,064 nm

Frequency f: 1 kHz

Pulse width w: 1 nsec

A laser light irradiation system for guiding the laser light emitted from the laser light source to the vibrating section was built up. The laser light irradiation system includes a beam expander, a half-wave plate, a polarizing beam splitter (PBS), and an objective lens.

The beam expander reshapes the beam shape of the laser beam emitted from the laser light source into a circular shape with a diameter of approximately 10 mm. Of the reshaped laser light, the amount of light is adjusted by a combination of the half-wave plate and the PBS. The laser light adjusted in the amount of light by the combination is converged by the objective lens, and then reaches the vibrating section.

It was verified whether or not the particle trapped in the well of the particle trapping chamber can be operated by the laser light from the laser light irradiation system, as follows. Note that, in the following verification, a K562 cell (average diameter: 15 μm) was used as the particle, and the particle trapping chamber was disposed in such a manner that the well is directed in the direction opposite to the acting direction of gravity, as depicted in FIG. 11.

As illustrated in FIG. 11, the laser light irradiation system was set to face observation light L1 of an upright microscope. In other words, the laser light irradiation system emits pulsed laser L2 toward the surface on the opposite side of the particle trapping chamber, substantially perpendicularly to the surface. The position of each component of the laser light irradiation system was adjusted in such a manner that the focal position of the pulsed laser L2 coincided with the focal position of an image observed under the upright microscope.

As has been described in (2) of 1 above, a cell-containing liquid was introduced from the fluid supply channel section into the particle trapping chamber and suction through the suction channel section was conducted, whereby one K562 cell each was trapped into each well of the particle trapping chamber.

Subsequently, by observation under the upright microscope, the cell to be driven out of the well was selected from plural cells trapped in the wells.

In order to take out the selected cell from the well, that position of the surface on the opposite side which corresponds to the position of the well (particularly, the vicinity of an opening of the hole provided in the well to the surface on the opposite side) was irradiated with pulsed laser of near infrared light under the following irradiation conditions.

<Laser Light Irradiation Conditions>

Objective lens numerical aperture: NA=0.28

Spot diameter: approximately 4 μm

Pulse energy: 5 μJ (average intensity 5 mw)

Number of irradiation pulses: 2

Pulse period: 1 msec

By the irradiation with the pulsed laser, the selected cell was moved out of the well in which it had been trapped. From this result, it is recognized that when the well provided with the vibrating section including a material that absorbs laser light of near infrared light is irradiated with the laser light, the cell trapped in the well can thereby be moved to the outside of the well.

In addition, since the pulse period is 1 msec and the number of irradiation pulses is 2, the period of time which may be required for taking out one cell is 2 msec, which is very short. Therefore, many cells can be taken out of the well at high speed.

Note that in the case where the pulse energy was, for example, 15 μJ and the number of irradiation pulses was increased to 50, there was a case where a cell also flied out from the well adjacent to the well in which the selected cell was trapped. In addition, when the pulse energy was lowered to 3 μJ, the frequency of a situation in which the cell was not moved and could not be taken out increased. From these results, it is recognized that by setting the pulse energy and the number of pulses to appropriate values, the cells can be taken out of the wells more accurately and more efficiently. Besides, since the period of time necessary for taking out one cell is determined by the number of pulses, it is understood that it is sufficient if the pulse energy is set in such a manner that the cell can be taken out of the well with a minimum number of pulses.

(1-2) Case where Layer of Gold-Palladium Alloy is not Sputtered

A particle trapping chamber which is the same as that described in (1) above, except that a layer of gold-palladium alloy was not formed by sputtering on the surface on the opposite side of the particle trapping chamber described in (1) above, was prepared. Using the particle trapping chamber thus prepared, the cell was trapped in the well in the same manner as described in (1) above and then, irradiation with the pulsed laser was conducted under the same conditions as above to try to take out the cell from the well. However, even upon irradiation with the pulsed laser, the cell in the well was not moved to the outside of the well.

The material of the substrate of the particle trapping chamber is a silicone resin, as described above. The silicone resin slightly absorbs the near infrared light. When the pulse energy was enhanced to 15 μm and the number of pulses was increased to 5, the cell could be moved from the inside of the well to the outside of the well by irradiation with the pulsed laser. However, unlike in the case described in (1) above, the movement of the cell failed in one run out of several runs.

(1-3) Movement of Particle Trapped in Well (Oblique Incidence of Laser Light)

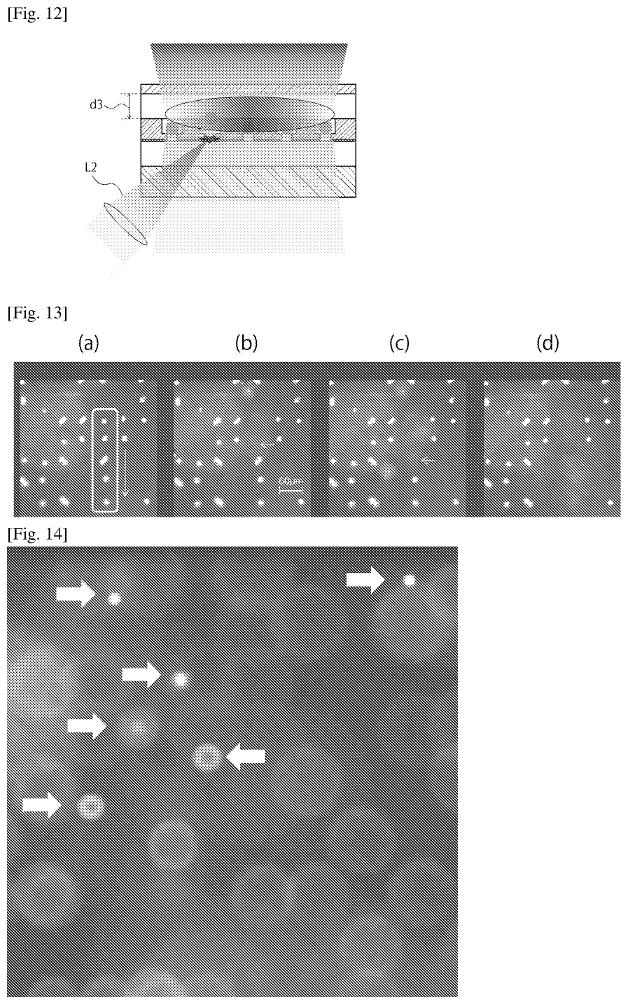

As illustrated in FIG. 12, the position of the laser light irradiation system was changed such that the pulsed laser L2 from the laser light irradiation system was obliquely incident. The incidence angle of the pulsed laser was 35°. In addition, of the components of the laser light irradiation system, the objective lens was replaced by a YAG laser condenser lens having a focal distance of 80 mm. The reason for the replacement by the condenser lens is that a long working distance may be needed such that the optical path of the pulsed laser and the optical path of observation do not interfere with each other. Upon the replacement, the numerical aperture was approximately 0.1. The laser light irradiation conditions were as follows.

<Laser Light Irradiation Conditions>

Objective lens numerical aperture: NA=0.1

Spot diameter: approximately 10 μm

Pulse energy: 32 μJ (average intensity 32 mw)

Number of irradiation pulses: 2

Pulse period: 1 msec

By the irradiation with the pulsed laser, the selected cell could be taken out, as in (1) above.

In addition, it is recognized that while the numerical aperture of the objective lens was lowered and the spot diameter was enlarged attendantly on the setting of oblique incidence, the results equivalent to those in the case of perpendicular incidence could be obtained by increasing the pulse energy and maintaining the energy surface density. The laser light irradiation system for irradiation with obliquely incident pulsed laser can easily be incorporated in an existing apparatus (for example, a commercially available single cell analyzer including a multiplicity of micro-wells arranged on a flat surface). The incidence angle of the laser light may appropriately be set, and may be set, for example, on the basis of a microscope, an optical base on which to mount the particle trapping chamber, and the lens holder diameter, etc. The incidence angle may be, for example, 30° to 85°, particularly 35° to 80°, and more particularly 40° to 80°.

(1-4) Verification of Damage to Cell

In the case where the pulse energy and the number of pulses, of the laser light irradiation conditions in (3) above, were slightly increased, the presence or absence of cell damage due to irradiation with the pulsed laser was checked, but damage to a cell membrane could not be confirmed.

(1-5) Verification of Damage to Cell by Use of Reagent

Taking out of the cell in the well was carried out using energy further stronger than that in the case of (4) above. In the cell taking out, the pulse energy was 40 μJ and the number of pulses was 5. In the cell taking out, the cells were preliminarily stained with a reagent for life/death determination (ethidium homodimer III). When damage to the cell membrane is generated, the reagent is taken into the inside of the cell, and red fluorescence is emitted.

Even upon the lapse of one hour after the irradiation with the pulsed laser, red fluorescence was not confirmed. Therefore, it is considered that even the above-mentioned pulse energy has a very low possibility of damaging the cell.

(1-6) Successive Taking Out of Particles

By using polystyrene fluorescent beads of a diameter of 10 μm in place of cells, the beads were trapped in each of the wells of the particle trapping chamber described in (1) above. Next, while irradiation with the pulsed laser was performed under the conditions described in (3) above, the stage with the particle trapping chamber mounted thereon was moved. In particular, by the movement, successive taking out of the beads (a total of six beads) trapped respectively in five wells was tried.

The results of the trial are depicted in FIG. 13. As depicted in (a) to (d) of FIG. 13, all the beads trapped in the five wells could be moved to the outside of the wells, sequentially from the bead in the upper-side well.

In addition, a situation in which the beads fly out from the well in the surroundings of these wells due to the irradiation with the pulsed laser was not generated.

Besides, bubbles which could visually be confirmed were not generated by the irradiation with the pulsed laser.

The focus of the microscope was moved upward of the well, and the presence of the six beads driven out of the wells by the irradiation with the pulsed laser was confirmed. The results of the confirmation are depicted in FIG. 14. The six beads were all present in areas ranging from the wells to the liquid in the chamber, and did not reach the chamber upper surface (a slide glass spaced by approximately 0.2 mm from the wells). Therefore, the moving speed of the beads when the beads are moved out of the wells is considered to be on the order of 10 mm/s. The shearing force exerted from the liquid, in the movement at the moving speed, is considered not to cause damage to the cells.

### (2) Particle Operation in Channel

(2-1) Confirmation of Generation of Turbulence of Laminar Flow

A microchannel chip having a configuration similar to that of the microchannel chip 300 described referring to FIG. 6 in (3-1) of 1 above was prepared. A liquid A and a liquid B were introduced respectively through the first inlet and the second inlet in the microchannel chip, and a laminar flow state in which a laminar flow A of the liquid A and a laminar flow B of the liquid B flow in parallel in the isolation determining channel (a channel with a diameter of 100 μm) was formed. The velocities of these laminar flows were both 10 mm/s.

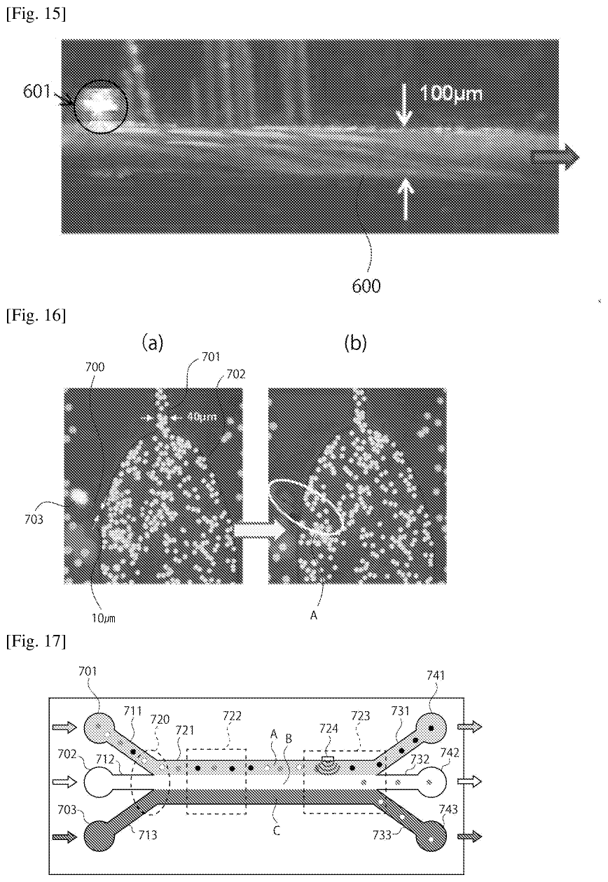

FIG. 15 depicts a photograph of part of the isolation determining channel. As depicted in FIG. 15, a near infrared light absorbing material 601 is provided at that part of a wall surface of the isolation determining channel 600 which is in contact with the laminar flow A. When the near infrared light absorbing material 601 was irradiated with pulsed laser of near infrared light, vibration of the near infrared light absorbing material was generated, turbulence of laminar flows was generated, and a flow from the laminar flow A toward the laminar flow B was formed primarily, as depicted in FIG. 15.

As described above, by the irradiation with the pulsed laser, a flow from the laminar flow A toward the laminar flow B can be formed primarily. It is therefore recognized that in the case where the laminar flow A contains particles, the particles can be moved from the laminar flow A into the laminar flow B by the irradiation with the pulsed laser.

(2-2) Generation of Vibration Having Directivity

As depicted in FIG. 16 (a), a channel structure including a channel 701 having a width of 40 μm and a space 702 to which the channel is connected was formed using PDMS. The channel structure was sandwiched between two cover glasses having a thickness of 0.15 mm, to form a microchannel. A wall surface of the space was formed with a hollow 700. The hollow 700 had such a shape that the sectional area gradually decreases from the inside of the hollow 700 toward a connection surface between the hollow 700 and the space 702 (had a shape like the hollow depicted in FIG. 7). The width of the hollow 700 at the connection surface between the hollow 700 and the space 702 was approximately 10 μm. A near infrared light absorbing metallic film 703 was formed on that part of the cover glass which corresponds to the hollow 700.

Beads having a diameter of 10 μm were permitted to flow through the channel having a width of 40 μm and go out into the space. FIG. 16(a) is a photograph depicting a state in which the beads are flowing.

The part where the metallic film was formed in the inside of the hollow was irradiated with pulsed laser of near infrared light. Vibration was generated by the irradiation, and, as depicted in the white-line ellipse in (b) of FIG. 16, the beads having been present in the vicinity of the connection surface between the hollow and the space were moved in the direction of the opening of the hollow. The moving direction of the beads coincided with the opening direction of the hollow. It is therefore recognized that vibration having directivity was generated by the irradiation of the near infrared light absorbing material provided in the hollow with the near infrared pulsed laser.

It should be understood by those skilled in the art that various modifications, combinations, sub-combinations, or substitutions are possible, in regard of the present technology described above, according, for example, to design requirements and other factors, within the scope of the present technology and equivalents thereof.

Note that the present technology may also take the following configurations.
(1)
A particle operating method including:
a transport step of irradiating a vibrating section including a material that absorbs laser light with the laser light in a pulsed form, to move a particle by vibration generated by the irradiation.
(2)
The particle operating method according to (1), in which
in the transport step, the particle is moved in such a manner that a moving direction of the particle is changed by the vibration.
(3)
The particle operating method according to (1), in which
in the transport step, the particle is moved from a predetermined place by the vibration.
(4)
The particle operating method according to any one of (1) to (3), in which
the vibrating section is included in a substrate, and the particle present in a well provided on the substrate is moved to outside of the well by the vibration.
(5)
The particle operating method according to (4), further including:
a recovery step of recovering the particle moved to the outside of the well.
(6)
The particle operating method according to (1), in which
the particle present in a channel is moved by the vibration.
(7)
The particle operating method according to (6), in which
in the transport step, the particle is moved in a predetermined moving direction by the vibration.
(8)
The particle operating method according to (6) or (7), in which
a side surface of the channel includes the vibrating section, and the particle present in the channel is moved by the vibration.
(9)
The particle operating method according to any one of (6) to (8), in which
the vibrating section is provided in a hollow provided in the side surface of the channel.
(10)
The particle operating method according to any one of (6) to (9), in which
plural laminar flows are formed in the channel, and the particle is moved from one laminar flow into another laminar flow by the vibration.
(11)
The particle operating method according to any one of (1) to (10), in which
the laser light includes laser light of infrared light.
(12)
The particle operating method according to any one of (1) to (11), in which
the particle includes a cell.
(13)
A particle trapping chip including:
a substrate;
at least one well provided on the substrate; and
a vibrating section that is included in the substrate and includes a material that absorbs laser light.
(14)
The particle trapping chip according to (13), in which
the vibrating section produces vibration by being irradiated with the laser light in a pulsed form.
(15)
A particle operating system including:
a particle trapping chip including a substrate, at least one well provided on the substrate, and a vibrating section that is included in the substrate and includes a material that absorbs laser light; and
a laser light irradiation section that irradiates the well with the laser light in a pulsed form.
(16)
The particle operating system according to (15), including:
a channel used for recovering the particle moved from inside of the well to outside of the well by laser light irradiation by the laser light irradiation section.
(17)
The particle operating system according to (15) or (16), in which
the particle trapping chip is movable relative to a position of the laser light irradiation section, and an irradiation position of the laser light is changed by the movement, or the laser light irradiation section includes an optical system by which the irradiation position of the laser light can be changed.
(18)
A particle trapping chamber including:
a substrate;
at least one well provided on the substrate;
a vibrating section that is included in the substrate and includes a material that absorbs laser light; and
a channel used for recovering the particle moved from inside of the well to outside of the well.

Moreover, note that the present technology may also take the following configurations.
(1)
A microfluidic system, comprising:
a microfluidic chip including:
a substrate having a vibrating section that, when irradiated by light, causes at least a portion of a substrate to vibrate; and
at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.
(2)
The microfluidic system of (1), wherein changing a position of the at least one particle comprises changing a direction or velocity of movement of the at least one particle.
(3)
The microfluidic system of (1), wherein the at least one particle is a cell.
(4)
The microfluidic system of (1), wherein the at least one microfluidic structure comprises a well, and wherein the at least one particle comprises at least one particle present in the well.
(5)
The microfluidic system of (4), wherein changing a position of the at least one particle comprises transporting the at least one particle out of the well.
(6)
The microfluidic system of (1), wherein the at least one microfluidic structure comprises a microfluidic channel.
(7)
The microfluidic system of (6), wherein the at least one particle comprises at least one particle flowing in a first laminar flow within the microfluidic channel.
(8)
The microfluidic system of (7), wherein changing a position of the at least one particle comprises moving the at least one particle from the first laminar flow to a second laminar flow within the microfluidic channel.
(9)
The microfluidic system of (6), wherein the vibrating section is configured to provide the vibration stimulus at an angle relative to a direction perpendicular to a wall of the microfluidic channel.
(10)
The microfluidic system of (9), wherein the microfluidic channel includes an intersection connected to at least two passages, and wherein the vibrating section is configured to provide the vibration stimulus at an angle such that the at least one particle when present in the microfluidic channel is moved into a particular one of the at least two passages at the intersection.
(11)
The microfluidic system of (1), wherein the vibrating section is a first vibrating section, and wherein the microfluidic system further comprises a second vibrating section separate from the first vibrating section.
(12)
The microfluidic system of (1), further comprising:
a light source configured to irradiate the vibrating section with light.
(13)
The microfluidic system of (12), wherein the light comprises near infrared light.
(14)
The microfluidic system of (12), further comprising:
a controller configured to control the light source to irradiate the vibrating section, wherein the controller is configured to change a direction or power of vibration of the vibrating section based, at least in part, on a type of particle present in the at least one microfluidic structure.
(15)
The microfluidic system of (1), further comprising:
a detector configured to detect information about the at least one particle when present in a detection region of the at least one microfluidic structure, wherein the vibration stimulus is provided in a portion of the at least one microfluidic structure other than the detection region.
(16)
The microfluidic system of (15), further comprising:
a controller configured to control vibration of the vibrating section based, at least in part, on the information about the at least one particle detected by the detector.
(17)
The microfluidic system of (1), wherein the vibration stimulus comprises a thermoelastic wave.
(18)
A microfluidic chip, comprising
a substrate having a vibrating section that, when irradiated by light, causes at least a portion of a substrate to vibrate; and
at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.
(19)
An operating method for a microfluidic system, the operating method comprising: irradiating a vibrating section of a substrate with light to cause vibration of at least a portion of the substrate, wherein the vibration of the at least a portion of the substrate causes a vibration stimulus within at least one microfluidic structure arranged adjacent to the at least a portion of the substrate.

### REFERENCE SIGNS LIST

1 Particle trapping chamber
100 Particle trapping chip
101 Substrate
105 Well

1. A microfluidic system, comprising:
a microfluidic chip including:
a substrate having a vibrating section that, when irradiated by light, causes at least a portion of a substrate to vibrate; and
at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.

2. The microfluidic system of claim 1, wherein changing a position of the at least one particle comprises changing a direction or velocity of movement of the at least one particle.

3. The microfluidic system of claim 1, wherein the at least one particle is a cell.

4. The microfluidic system of claim 1, wherein the at least one microfluidic structure comprises a well, and wherein the at least one particle comprises at least one particle present in the well.

5. The microfluidic system of claim 4, wherein changing a position of the at least one particle comprises transporting the at least one particle out of the well.

6. The microfluidic system of claim 1, wherein the at least one microfluidic structure comprises a microfluidic channel.

7. The microfluidic system of claim 6, wherein the at least one particle comprises at least one particle flowing in a first laminar flow within the microfluidic channel.

8. The microfluidic system of claim 7, wherein changing a position of the at least one particle comprises moving the at least one particle from the first laminar flow to a second laminar flow within the microfluidic channel.

9. The microfluidic system of claim 6, wherein the vibrating section is configured to provide the vibration stimulus at an angle relative to a direction perpendicular to a wall of the microfluidic channel.

10. The microfluidic system of claim 9, wherein the microfluidic channel includes an intersection connected to at least two passages, and wherein the vibrating section is configured to provide the vibration stimulus at an angle such that the at least one particle when present in the microfluidic channel is moved into a particular one of the at least two passages at the intersection.

11. The microfluidic system of claim 1, wherein the vibrating section is a first vibrating section, and wherein the microfluidic system further comprises a second vibrating section separate from the first vibrating section.

12. The microfluidic system of claim 1, further comprising:
a light source configured to irradiate the vibrating section with light.

13. The microfluidic system of claim 12, wherein the light comprises near infrared light.

14. The microfluidic system of claim 12, further comprising:
a controller configured to control the light source to irradiate the vibrating section, wherein the controller is configured to change a direction or power of vibration of the vibrating section based, at least in part, on a type of particle present in the at least one microfluidic structure.

15. The microfluidic system of claim 1, further comprising:
a detector configured to detect information about the at least one particle when present in a detection region of the at least one microfluidic structure, wherein the vibration stimulus is provided in a portion of the at least one microfluidic structure other than the detection region.

16. The microfluidic system of claim 15, further comprising:
a controller configured to control vibration of the vibrating section based, at least in part, on the information about the at least one particle detected by the detector.

17. The microfluidic system of claim 1, wherein the vibration stimulus comprises a thermoelastic wave.

18. A microfluidic chip, comprising
a substrate having a vibrating section that, when irradiated by light, causes at least a portion of a substrate to vibrate; and
at least one microfluidic structure arranged adjacent to the vibrating section such that vibration of the at least a portion of the substrate causes a vibration stimulus within the at least one microfluidic structure, the vibration stimulus causing a change in position of at least one particle when present in the at least one microfluidic structure.

19. An operating method for a microfluidic system, the operating method comprising:
irradiating a vibrating section of a substrate with light to cause vibration of at least a portion of the substrate, wherein the vibration of the at least a portion of the substrate causes a vibration stimulus within at least one microfluidic structure arranged adjacent to the at least a portion of the substrate.
